(19) United States
(12) Patent Application Publication
(10) Pub. No.: US 2021/0064586 A1
(43) Pub. Date: Mar. 4, 2021

(54) DATA PROCESSING DEVICE AND DATA PROCESSING METHOD

(71) Applicant: HONDA MOTOR CO., LTD., Tokyo (JP)

(72) Inventor: Daisuke SAKAMOTO, Tokyo (JP)

(21) Appl. No.: 17/009,185

(22) Filed: Sep. 1, 2020

(30) Foreign Application Priority Data
Sep. 4, 2019 (JP) 2019-161263

(51) Int. Cl. G06F 16/21; G06F 16/23

(52) U.S. Cl. CPC G06F 16/21; G06F 16/2365

(57) ABSTRACT

Provided is a data processing device capable of improving creation efficiency and database usefulness at the time of creating a database. A data processing device 1 acquires a plurality of text information items from information published on a predetermined media under a predetermined acquisition condition (STEP 1), creates, when at least a part of each of the plurality of text information items displayed on a display 1a is designated as an exclusion keyword by a user, a noise-removed information item obtained by removing text information including the exclusion keyword from the text information items (STEP 2), and creates a database by performing predetermined processing on the noise-removed information item (STEPs 3 and 4).

### BACKGROUND OF THE INVENTION

### Field of the Invention

The present invention relates to a data processing device that performs database creation and the like.

### Description of the Related Art

In related arts, a data processing device disclosed in Japanese Patent Laid-Open No. 2011-48527 has been known. In the data processing device, a search target database is created by extracting a sensitivity expression from Japanese text information and associating sensitivity information and side information with a search target using a created sensitivity expression database.

Next, when a user inputs the sensitivity expression as a search condition, the sensitivity information and the side information corresponding to the sensitivity expression are acquired from the sensitivity expression database, the search target database is searched for the sensitivity information according to the side information, and a distance between the sensitivity information acquired from the search target database and the sensitivity information acquired from the sensitivity expression database is calculated. Then, various information items such as a search target ID are displayed side by side on a screen in order from the closest distance.

According to the data processing device disclosed in Japanese Patent Laid-Open No. 2011-48527, since the search target database is merely created from Japanese text information and a data collection range is restricted, there is a problem that the search target database is low in terms of usefulness. In addition, since noise, which is unnecessary information having no value in use, is not considered, the search target database may be created with noise. In this case, the creation efficiency of the search target database is reduced, and the usefulness of the search target database is further reduced.

The present invention has been made to solve the above problems, and is to provide data processing device capable of improving the creation efficiency and database usefulness at the time of creating a database.

### SUMMARY OF THE INVENTION

In order to achieve the above object, according to a first aspect of the present invention, a data processing device includes: an output interface; an input interface configured to be operated by a user; a text information acquisition unit configured to acquire a plurality of text information items from information published on a predetermined media under a predetermined acquisition condition; a text information display unit configured to display the plurality of text information items on the output interface; a noise-removed information creation unit configured to, when at least a part of each of the plurality of text information items displayed on the output interface is designated as noise by an operation of the input interface from the user, create a noise-removed information item which is text information obtained by removing text information including the part designated as the noise from the plurality of text information items; and a database creation unit configured to create a database by performing predetermined processing on the noise-removed information item.

According to the data processing device, the plurality of first text information are acquired from the information published on the predetermined media under the predetermined acquisition condition, and the plurality of text information items are displayed on the output interface. Then, when at least a part of each of the plurality of text information items displayed on the output interface is designated as noise by the operation of the input interface from the user, the noise-removed information item is created which is text information obtained by removing text information including the part designated as the noise from the plurality of text information items. As described above, it is possible to easily and appropriately remove the text information including the data regarded as the noise by the user from the plurality of text information items only by selecting the noise with the operation of the input interface from the user, and to create the noise-removed information item as a result of the removal.

Further, since the noise-removed information item created in such a manner is subjected to the predetermined processing and thus the database is created, it is possible to create the database in a state where the text information regarded as the noise by the user is excluded. Thereby, the creation efficiency and database usefulness at the time of creating a database can be improved.

According to a second aspect of the present invention, in the data processing device according to the first aspect, the data processing device further includes: a noise storage unit configured to store the noise; and a noise display unit configured to display the noise stored in the noise storage unit on the output interface when a display operation of the noise is executed by the operation of the input interface from the user.

According to the data processing device, when the display operation of the noise is executed by the operation of the input interface from the user, the noise stored in the noise storage unit is displayed on the output interface, so that the user can visually recognize the noise selected up to the present time by the user. Thereby, convenience can be improved.

According to a third aspect of the present invention, in the data processing device according to the first aspect, the text information acquisition unit extracts sensitivity information from the information published on the predetermined media, and acquires the plurality of text information items as information in which the sensitivity information is associated with the information published on the predetermined media, the data processing device further includes a noise-removed information display unit configured to display the noise-removed information item on the output interface together with the sensitivity information associated with the noise-removed information item, and the predetermined processing of the database creation unit includes sensitivity information correction processing of correcting the sensitivity information in the one or more noise-removed information items displayed on the output interface, the sensitivity information correction processing being executed by the operation of the input interface from the user.

According to the data processing device, the sensitivity information is extracted from the information published on the predetermined media, the plurality of text information items are acquired as the information in which the sensitivity information is associated with the information published on the predetermined media, and the noise-removed information item is displayed on the output interface together with the sensitivity information. Then, since the sensitivity information correction processing is executed by the operation of the input interface from the user at the time of creating the database to correct the sensitivity information in the noise-removed information item displayed on the output interface, the user can visually recognize and easily correct the sensitivity information in the noise-removed information item. Thereby, the creation efficiency and database usefulness at the time of creating a database can be improved.

According to a fourth aspect of the present invention, in the data processing device according to the first aspect, the data processing device further includes a tag information storage unit configured to store tag information defined by the user, and the predetermined processing of the database creation unit includes association processing of associating the noise-removed information item with the tag information stored in the tag information storage unit.

According to the data processing device, since the association processing of associating the noise-removed information item with the tag information stored in the tag information storage unit is executed at the time of creating the database, a database search can be executed based on the tag information and the usefulness of the database can be further improved.

According to a fifth aspect of the present invention, in the data processing device according to the first aspect, the text information display unit displays sets of text information on the output interface in order from a largest set, the sets of information each including identical information or identical and similar information when the plurality of text information items are sorted according to meaning of information included in the plurality of text information items.

According to the data processing device, since the sets of text information including the identical information or the identical and similar information when the plurality of text information items are sorted according to the meaning of the information included in the plurality of text information items are displayed on the output interface in order from the largest set, the user can designate the noise in order from the largest text information set. Thereby, the text information including the noise can be efficiently removed from the plurality of text information items. Thus, the creation efficiency at the time of creating a database can be further improved.

According to a sixth aspect of the present invention, in the data processing device according to the third aspect, the database creation unit creates the database in a state where the sensitivity information is sorted into a plurality of categories, and the data processing device includes a sensitivity information display unit configured to display the sensitivity information on the output interface in different colors, the sensitivity information being sorted into the plurality of categories and included in the database.

According to the data processing device, since the sensitivity information sorted into the plurality of categories and included in the database is displayed on the output interface in different colors, the user can easily identify and visually recognize the plurality of categories of sensitivity information.

According to a seventh aspect of the present invention, in the data processing device according to the first aspect, the predetermined acquisition condition is a condition that the information published on the predetermined media includes predetermined information and does not include predetermined confusion information which is confusable with the predetermined information.

According to the data processing device, since the plurality of text information items are acquired from the information published on the predetermined media under the condition that the information published on the predetermined media includes the predetermined information and does not include the predetermined confusion information which is confusable with the predetermined information, the plurality of text information items can be acquired as information including the predetermined information with accuracy. Thereby, the creation efficiency at the time of creating a database can be further improved.

In order to achieve the above object, according to an eighth aspect, a data processing method includes: acquiring a plurality of text information items from information published on a predetermined media under a predetermined acquisition condition; displaying the plurality of text information items on the output interface; creating a noise-removed information item which is text information obtained by removing text information including the part designated as the noise from the plurality of text information items when at least a part of each of the plurality of text information items displayed on the output interface is designated as noise by an operation of the input interface from the user; and creating a database by performing predetermined processing on the noise-removed information item.

### BRIEF DESCRIPTION OF THE DRAWINGS

FIG. 1 is a diagram illustrating a configuration of a data processing device according to an embodiment of the present invention;

FIG. 2 is a flowchart illustrating database creation processing;

FIG. 3 is a flowchart illustrating data acquisition processing;

FIG. 4 is a flowchart illustrating data cleansing processing;

FIG. 5 is a flowchart illustrating sensitivity information correction processing;

FIG. 6 is a flowchart illustrating user-definition tagging processing;

FIG. 7 is a flowchart illustrating data visualization processing;

FIG. 8 is a diagram illustrating a media selection screen in the data acquisition processing;

FIG. 9 is a diagram illustrating a period input screen;

FIG. 10 is a diagram illustrating a language selection screen;

FIG. 11 is a diagram illustrating a keyword input screen;

FIG. 12 is a diagram illustrating an additional information selection screen;

FIG. 13 is a diagram illustrating a final confirmation screen in the data acquisition processing;

FIG. 14 is a diagram illustrating a data selection screen in the data cleansing processing;

FIG. 15 is a diagram illustrating a cleansing keyword screen;

FIG. 16 is a diagram illustrating a state in which an exclusion keyword is selected on the screen of FIG. 15;

FIG. 17 is a diagram illustrating a state in which an input window and a display window are displayed on the screen of FIG. 15;

FIG. 18 is a diagram illustrating a final confirmation screen in the data cleansing processing;

FIG. 19 is a diagram illustrating a data selection screen in the sensitivity information correction processing;

FIG. 20 is a diagram illustrating a sensitivity correction screen;

FIG. 21 is a diagram illustrating a state in which a pull-down menu is displayed on the screen of FIG. 20;

FIG. 22 is a diagram illustrating a final confirmation screen in the sensitivity information correction processing;

FIG. 23 is a diagram illustrating a data selection screen in the user-definition tagging processing;

FIG. 24 is a diagram illustrating a user-definition tag selection screen;

FIG. 25 is a diagram illustrating a user-definition tag screen;

FIG. 26 is a diagram illustrating a data selection screen in the data visualization processing;

FIG. 27 is a diagram illustrating an initial display screen;

FIG. 28 is a diagram illustrating a related screen of a minor category “inquiry”; and

FIG. 29 is a diagram illustrating a related screen of a minor category “CUB”.

### DETAILED DESCRIPTION OF THE PREFERRED EMBODIMENTS

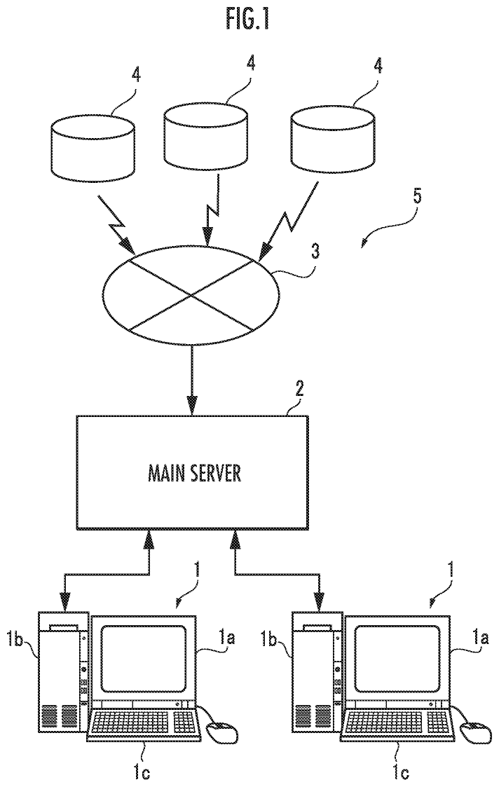

A data processing device according to an embodiment of the present invention will be described below with reference to the drawings. FIG. 1 illustrates a data processing system 5 to which a data processing device 1 of the present embodiment is applied, and the data processing system 5 includes a plurality of data processing devices 1 (only two are illustrated) and a main server 2.

The main server 2 includes a storage, a processor, a memory (for example, RAM, E2PROM, or ROM) and an I/O interface. A large number of external servers 4 (only three are illustrated) are connected to the main server 2 via a network 3 (for example, Internet).

In this case, various SNS servers, servers of predetermined media (for example, newspaper companies), and servers of search sites correspond to the external servers 4. The data processing device 1 acquires text data (text information) from such external servers 4 via the main server 2 as will be described below.

In addition, the data processing device 1 is of a PC type, and includes a display 1a, a device body 1b, and an input interface 1c. The device body 1b includes a storage such as an HDD, a processor, and a memory (RAM, E2PROM, or ROM) (none are illustrated), and application software for data acquisition (hereinafter, referred to as “data acquisition software”) is installed in the storage of the device body 1b.

Further, the input interface 1c includes a keyboard and a mouse configured to operate the data processing device 1. In the present embodiment, the display 1a corresponds to an output interface, and the device body 1b corresponds to a text information acquisition unit, a text information display unit, a noise-removed information creation unit, a database creation unit, a noise storage unit, a noise display unit, a noise-removed information display unit, a tag information storage unit, and a sensitivity information display unit.

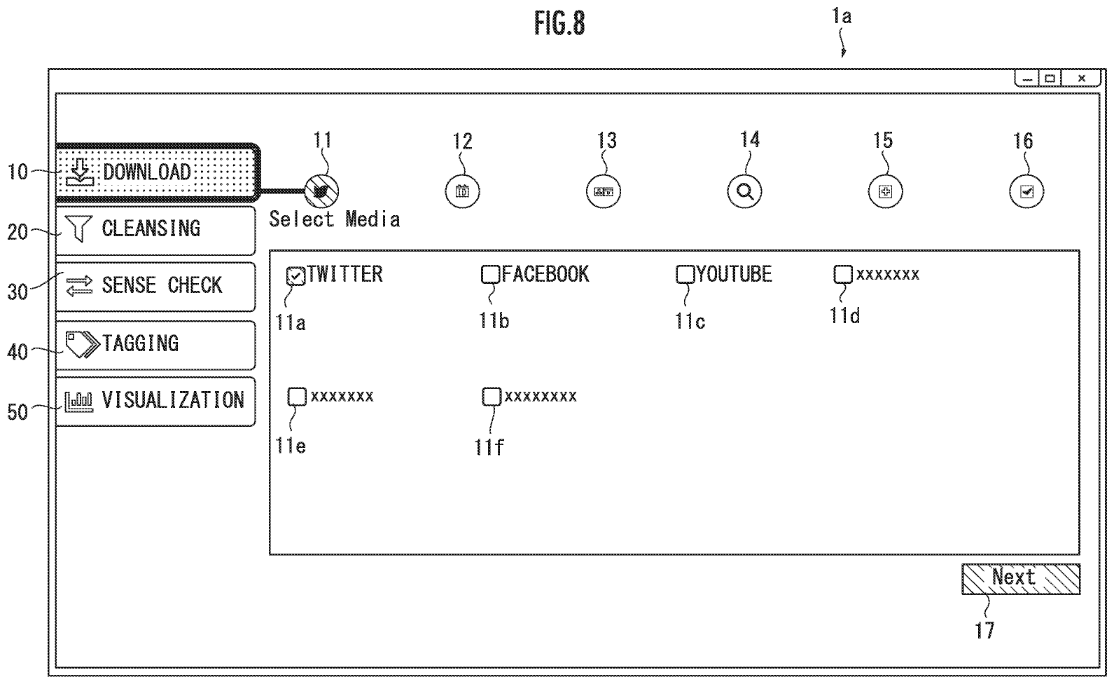

In the data processing device 1, database creation processing is executed as will be described below. Specifically, when the data acquisition software starts up with an operation of the input interface 1c from a user, a screen as illustrated in FIG. 8 to be described below is displayed on the display 1a as a GUI (Graphical User Interface).

In the case of the GUI, a data acquisition button 10, a data cleansing button 20, a sensitivity correction button 30, a tagging button 40, and a visualization button 50 are displayed vertically in a row on a left side of the display 1a. Then, the user presses these buttons via the input interface 1c, thereby database creation processing is executed as will be described below. In the following description, the operation of the input interface 1c from the user is referred to as “user operation”.

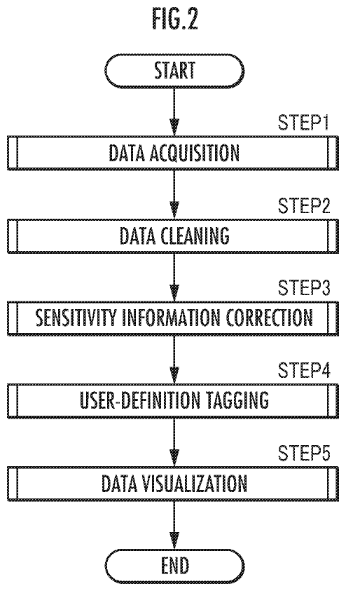

The above-described database creation processing will be described below with reference to FIG. 2. As will be described below, the database creation processing is executed at a predetermined control cycle in the data processing device 1 in such a manner that text information is acquired from the external server 4 while the data acquisition software starts up to create a database and the creation result is displayed.

Note that any data acquired or created during the execution of the database creation processing is stored in the storage of the device body 1b of the data processing device 1. Further, such data may be configured to be stored in the memory of the device body 1b, the storage externally attached to the device body 1b, or the main server 2.

As illustrated in FIG. 2, first, data acquisition processing is executed in the database creation processing (STEP 1 in FIG. 2). Such processing is to acquire text data from the external server 4, and details thereof will be described below.

Next, data cleansing processing is executed (STEP 2 in FIG. 2). Such processing is to read out the text data in the storage of the device body 1b and remove unnecessary data contained in the read text data to clean the text data, and details thereof will be described below.

Subsequently, sensitivity information correction processing is executed (STEP 3 in FIG. 2). Such processing is to read out the text data in the storage of the device body 1b and correct sensitivity information in the read text data, and details thereof will be described below.

Subsequent to the sensitivity information correction processing, user-definition tagging processing is executed (STEP 4 in FIG. 2). Such processing is to read out the text data in the storage of the device body 1b and add a user-definition tag to the read text data, and details thereof will be described below.

Next, data visualization processing is executed (STEP 5 in FIG. 2). Such processing is to visualize and display the database created by the execution of the respective types of processing described above, and details thereof will be described below. After the data visualization processing is executed as described above, the database creation processing is ended.

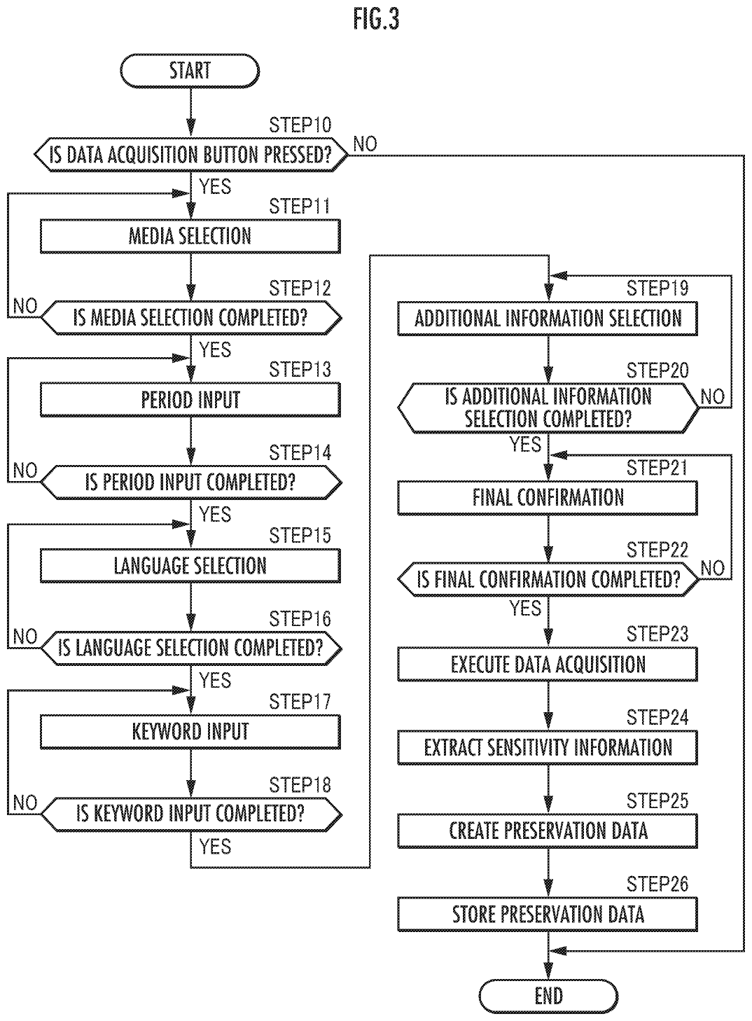

The contents of the above-described data acquisition processing will be described below with reference to FIG. 3. In this processing, as illustrated in FIG. 3, first, it is determined whether the above-described data acquisition button 10 is pressed by the user operation (STEP 10 in FIG. 3). When such determination is negative (NO in STEP 10 in FIG. 3), the processing is ended immediately.

On the other hand, when such determination is affirmative (YES in STEP 10 in FIG. 3), and the data acquisition button 10 is pressed, media selection processing is executed (STEP 11 in FIG. 3). In the media selection processing, a media selection screen as illustrated in FIG. 8 is displayed on the display 1a.

In the media selection screen, the data acquisition button 10 is configured such that an outer frame is displayed with a thick line and an inside is displayed in a shaded state to indicate that the data acquisition button 10 is pressed as described above.

On an upper side of the media selection screen, a media selection icon 11, a period input icon 12, a language selection icon 13, a keyword input icon 14, an additional information selection icon 15, and a final confirmation icon 16 are displayed in this order from left to right. In addition, a Next button 17 is displayed on a lower right side of the media selection screen.

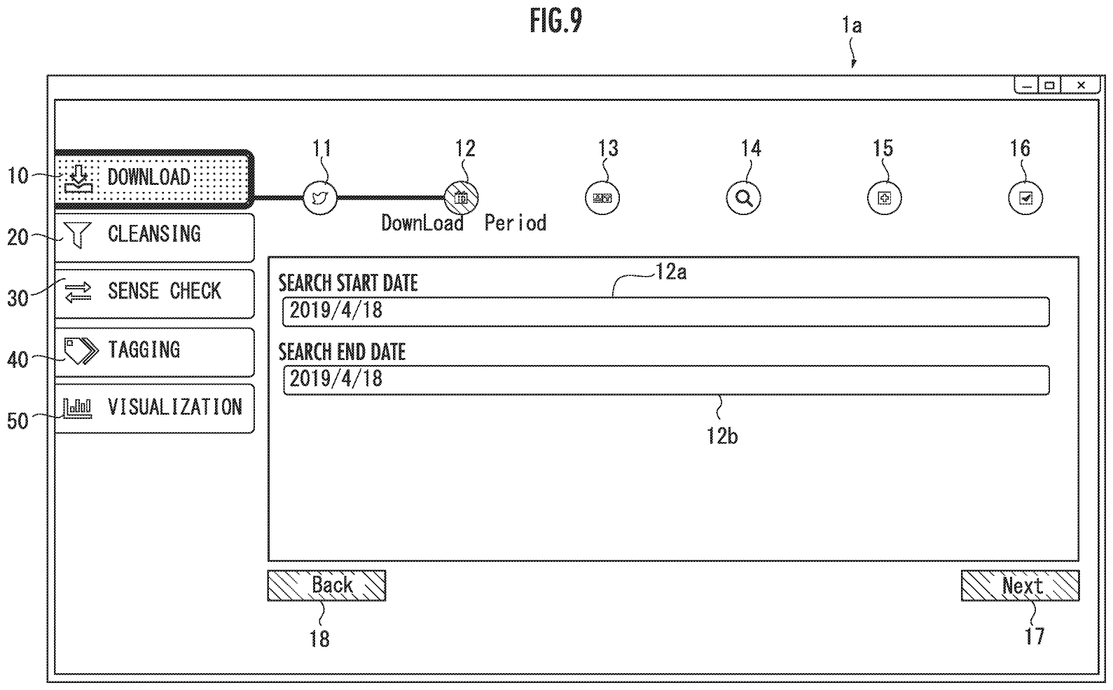

In order to indicate that the media selection processing is being executed, the media selection icon 11 is inversely displayed and characters “Select Media” are displayed below the icon. In FIG. 8, the inversely displayed state of the media selection icon 11 is not displayed with black but is displayed by hatching. This shall be applied to various icons 12 to 16 in FIGS. 9 to 13 to be described below.

Further, during the execution of the media selection processing, a plurality of check boxes are displayed in a center of the media selection screen to select media. In the example illustrated in FIG. 8, six check boxes 11a to 11f are displayed as the plurality of check boxes.

In this case, the check boxes 11a to 11c are used to select “TWITTER (registered trademark)”, “FACEBOOK (registered trademark)”, and “YOUTUBE (registered trademark)” as media, respectively, and the check boxes 11d to 11f are used to select the other three media, respectively.

The check box corresponding to the selected media is checked and the check box is inversely displayed at the same time to indicate that any of the media is selected by the user operation in the state where the check boxes 11a to 11f are displayed as described above. In the example illustrated in FIG. 8, a state is displayed in which TWITTER (registered trademark) is selected as the media. As described above, the media selection processing is executed.

Next, it is determined whether the media selection processing is completed (STEP 12 in FIG. 3). In this case, when the Next button 17 is pressed by the user operation in a state where at least one of the check boxes 11a to 11f is selected, it is determined that the media selection processing is completed, and it is determined in other cases that the media selection processing is not completed.

When the determination is negative (NO in STEP 12 in FIG. 3), the process returns to the media selection processing described above. On the other hand, when the determination is affirmative (YES in STEP 12 in FIG. 3) and the media selection processing is completed, period input processing is executed (STEP 13 in FIG. 3).

The period input processing is to input a period at which the text data is acquired from the media selected as described above, and during the execution of the period input processing, a period input screen is displayed on the display 1a as illustrated in FIG. 9.

In the period input screen, the period input icon 12 is inversely displayed to indicate that the period input processing is being executed. In a center of the period input screen, an input field 12a is displayed to input a search start date which is a start point of a data acquisition period, and an input field 12b is displayed to input a search end date which is an end point of the data acquisition period.

Further, a Back button 18 is displayed on a lower left side of the period input screen. The Back button 18 is used to return to the screen of the processing (that is, the media selection processing) before the period input processing, and this shall be applied to various screens for processing to be described below. In the period input processing, the search start date and the search end date are input to the input fields 12a and 12b by the user operation. The period input processing is executed as described above.

Next, it is determined whether the period input processing is completed (STEP 14 in FIG. 3). In this case, it is determined that the period input processing is completed when the Next button 17 is pressed by the user operation in the state where the search start date and the search end date are input to the input fields 12a and 12b, and it is determined in other cases that the period input processing is not completed.

When the determination is negative (NO in STEP 14 in FIG. 3), the process returns to the period input processing described above. On the other hand, when the determination is affirmative (YES in STEP 14 in FIG. 3) and the period input processing is completed, language selection processing is executed (STEP 15 in FIG. 3).

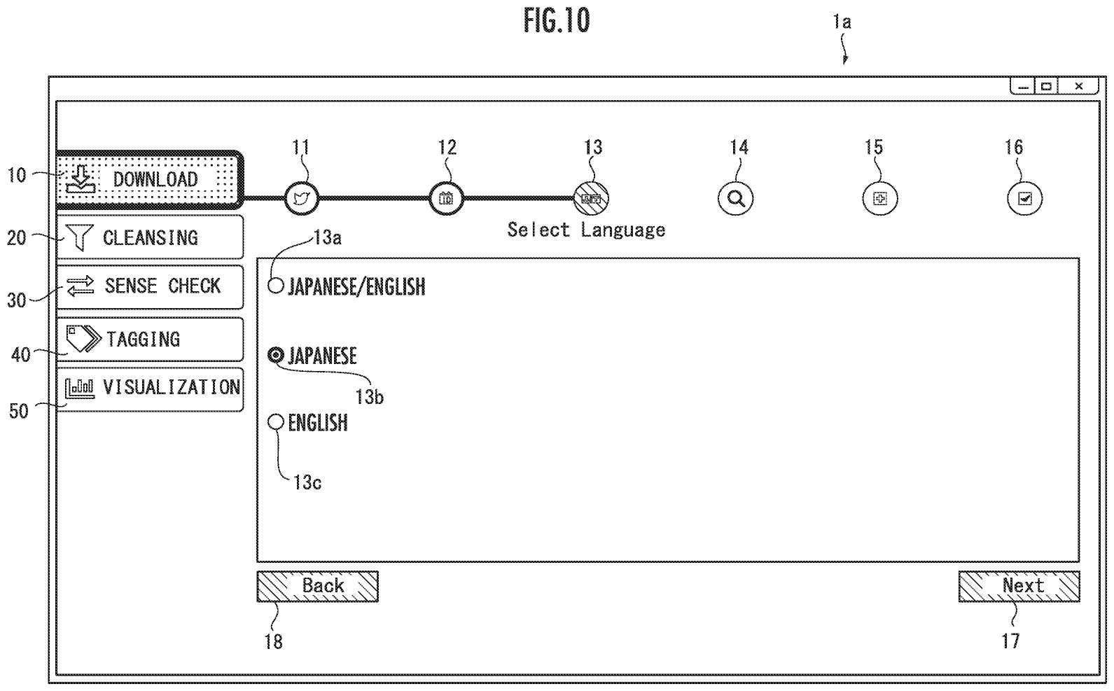

The language selection processing is to select a language for acquiring the text data from the media selected as described above, and during the execution of the language selection processing, a language selection screen is displayed on the display 1a as illustrated in FIG. 10. In the language selection screen, the language selection icon 13 is inversely displayed and characters “Select Language” are displayed below the icon to indicate that the language selection processing is being executed.

Further, three check boxes 13a to 13c are vertically displayed side by side on a left side of the language selection screen. The check box 13a is used to select both Japanese and English as the language for acquiring the text data, and characters “Japanese/English” are displayed on a right side of the check box 13a to indicate such usage.

In addition, the check box 13b is used to select Japanese as the language for acquiring the text data, and a character “Japanese” is displayed on a right side of the check box 13b to indicate such usage. Further, the check box 13c is used to select English as the language for acquiring the text data, and a character “English” is displayed on a right side of the check box 13c to indicate such usage.

In order to indicate that any of the languages is selected by the user operation in the state where the check boxes 13a to 13c are displayed as described above, the check box corresponding to the selected media is checked and the check box is inversely displayed at the same time. In the example illustrated in FIG. 10, a state is displayed in which Japanese is selected as the language for acquiring the text data. The language selection processing is executed as described above.

Next, it is determined whether the language selection processing is completed (STEP 16 in FIG. 3). In this case, it is determined that the language selection processing is completed when the Next button 17 is pressed by the user operation in the state where any of the check boxes 13a to 13c is checked, and it is determined in other cases that the language selection processing is not completed.

When the determination is negative (NO in STEP 16 in FIG. 3), the process returns to the language selection processing described above. On the other hand, when the determination is affirmative (YES in STEP 16 in FIG. 3) and the language selection processing is completed, keyword input processing is executed (STEP 17 in FIG. 3).

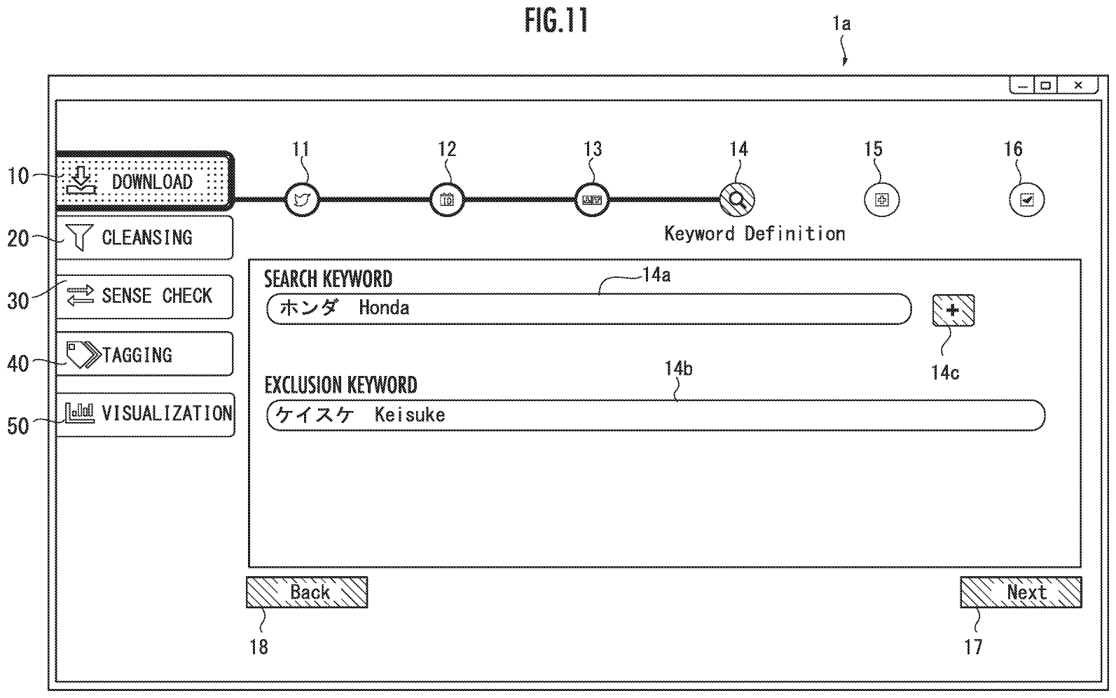

The keyword input processing is to input a search keyword and an exclusion keyword during acquisition of the text data from the external server 4, and during execution of the keyword input processing, a keyword input screen is displayed on the display 1a as illustrated in FIG. 11.

In the keyword input screen, the keyword input icon 14 is inversely displayed and characters “Keyword Definition” are displayed on a lower side of the keyword input icon 14 to indicate that the keyword input processing is being executed.

Further, two input fields 14a and 14b and an Add button 14c are displayed in a center of the keyword input screen. The input field 14a is used to input a search keyword, and characters “Search Keyword” are displayed above the input field 14a to indicate such usage. Further, the Add button 14c is used to add the input field 14a.

In addition, the input field 14b is used to input an exclusion keyword, and characters “Exclusion Keyword” are displayed above the input field 14b to indicate such usage. The reason for using the exclusion keyword is as follows.

In other words, when the text data is acquired from the external server 4, if the text data in the external server 4 retains keywords that is not related to the search keyword but is equal to or similar to the search keyword, it is highly possible that such text data will be acquired in a state of being confused with the original text data. Therefore, the exclusion keyword is used to avoid acquisition of such unnecessary text data.

In the keyword input processing, the search keyword and the exclusion keyword are input by the user operation in a state where the keyword input screen is displayed. FIG. 11 shows an example in which honda (in Japanese “ [symbol] ”) and Honda (registered trademark) are input as search keywords and keisuke (in Japanese “ [symbol] ”) and Keisuke are input as exclusion keywords. In the case of the example, text data retaining one of the honda and the Honda is acquired (searched for), and acquisition of text data retaining one of the keisuke and the Keisuke is stopped. The keyword input processing is executed as described above.

Next, it is determined whether the keyword input processing is completed (STEP 18 in FIG. 3). In this case, it is determined that the keyword input processing is completed when the Next button 17 is pressed by the user operation in the state where the keywords are input to the two input fields 14a and 14b, and it is determined in other cases that the keyword input processing is not completed.

When the determination is negative (NO in STEP 18 in FIG. 3), the process returns to the keyword input processing described above. On the other hand, when the determination is affirmative (YES in STEP 18 in FIG. 3) and the keyword input processing is completed, additional information selection processing is executed (STEP 19 in FIG. 3).

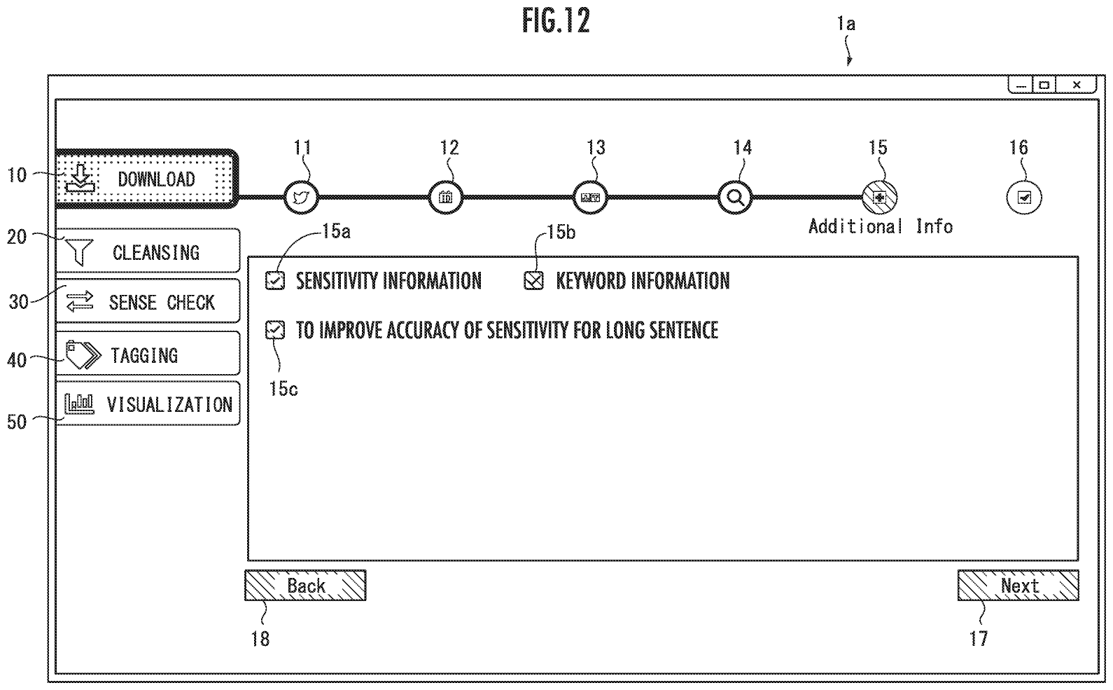

The additional information selection processing is to select information to be added to the text data when the text data is acquired from the media selected as described above, and during execution of the additional information selection processing, an additional information selection screen is displayed on the display 1a as illustrated in FIG. 12.

In the additional information selection screen, the additional information selection icon 15 is inversely displayed and characters “Additional Info” are displayed below the icon to indicate that the additional information selection processing is being executed. In addition, three check boxes 15a to 15c are displayed on a left side of the additional information selection screen. The check box 15a is used to add sensitivity information to be described below to the acquired data, and characters “sensitivity information” are displayed on a right side of the check box 15a to indicate such usage.

In addition, the check box 15b is used to add information related to the keyword to the acquired data, and characters “Keyword Information” are displayed on a right side of the check box 15b to indicate such usage. Further, the check box 15c is used to improve the accuracy of the sensitivity information for long sentences, and characters “Improvement in accuracy of sensitivity information for long sentences” are displayed on a right side of the check box 15c to indicate such usage.

In order to indicate that any of the check boxes 15a to 15c is selected by the user operation in the state where the check boxes 15a to 15c are displayed as described above, the selected check box is checked and the check box is inversely displayed at the same time. In the example illustrated in FIG. 12, all three check boxes 15a to 15c are selected. The additional information selection processing is executed as described above.

Next, it is determined whether the additional information selection processing is completed (STEP 20 in FIG. 3). In this case, it is determined that the additional information selection processing is completed when the Next button 17 is pressed by the user operation in the state where any of the check boxes 15a to 15c is checked, and it is determined in other cases that the additional information selection processing is not completed.

When the determination is negative (NO in STEP 20 in FIG. 3), the process returns to the additional information selection processing described above. On the other hand, when the determination is affirmative (YES in STEP 20 in FIG. 3) and the additional information selection processing is completed, final confirmation processing is executed (STEP 21 in FIG. 3).

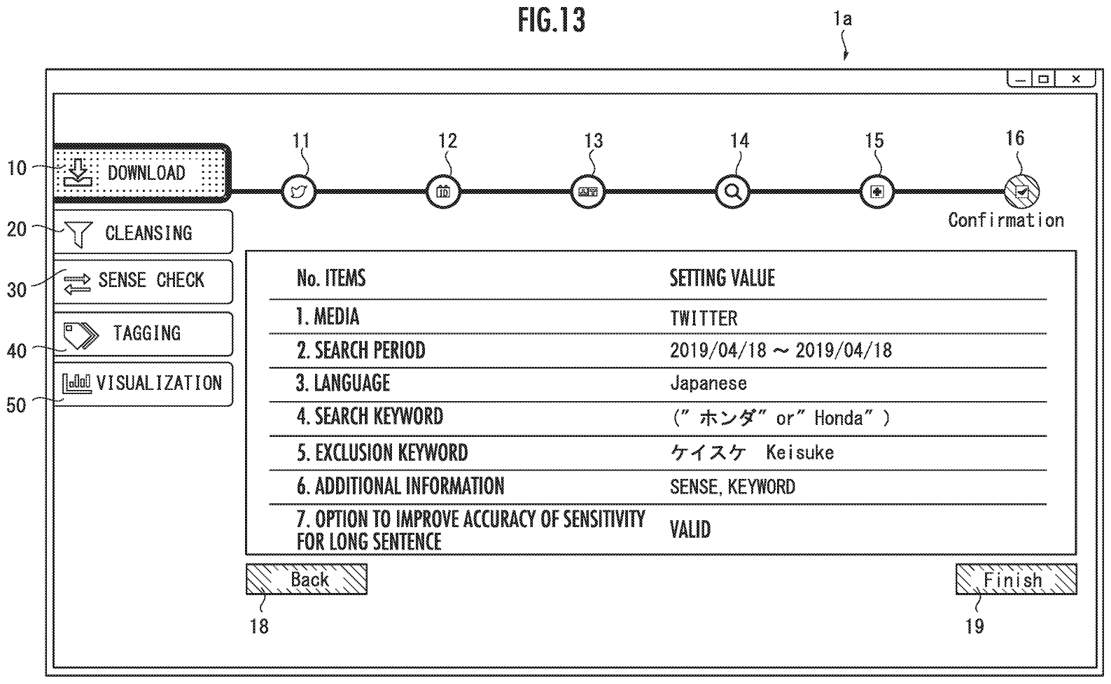

The final confirmation processing is to finally confirm the result selected and input by the user as described above, and during execution of the final confirmation processing, a final confirmation screen is displayed on the display 1a as illustrated in FIG. 13.

In the final confirmation screen, the final confirmation icon 16 is inversely displayed and a character “Confirmation” is displayed below the icon to indicate that the final confirmation processing is being executed. In addition, various items set as described above and setting values of such items are displayed in a center of the final confirmation screen, and a Finish button 19 is displayed on a lower right side of the screen. The final confirmation processing is executed as described above.

Next, it is determined whether the final confirmation processing is completed (STEP 22 in FIG. 3). In this case, it is determined that the final confirmation processing is completed when the Finish button 19 is pressed by the user operation in the state where the final confirmation screen is displayed, and it is determined in other cases that the final confirmation processing is not completed.

When the determination is negative (NO in STEP 22 in FIG. 3), the process returns to the final confirmation processing described above. On the other hand, when the determination is affirmative (YES in STEP 22 in FIG. 3) and the final confirmation processing is completed, the data acquisition processing is executed (STEP 23 in FIG. 3).

Specifically, the text data is acquired from the external server 4 of the media selected as described above via the main server 2, under various conditions set by the user as described above. In this case, when both Japanese and English are selected as the language for acquiring the text data, mixture data of English machine-translated text data and Japanese text data is acquired as text data. In this case, the text data may be acquired from the external server 4 by the data processing device 1 without using the main server 2.

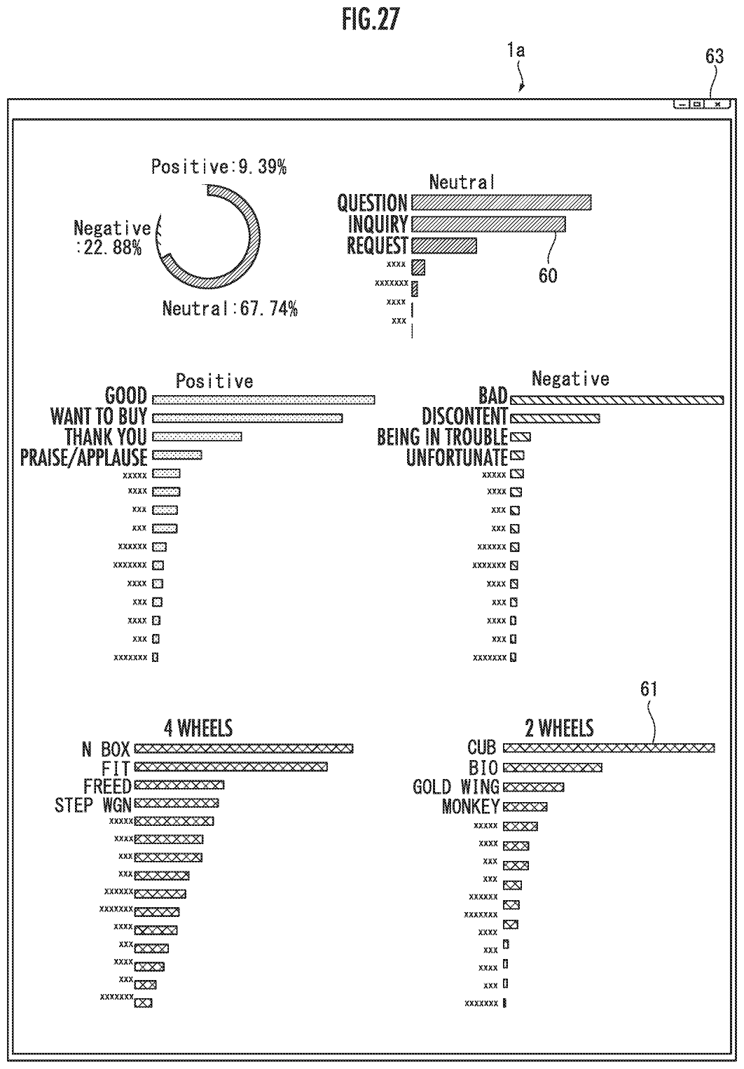

Subsequently, sensitivity information extraction processing is executed (STEP 24 in FIG. 3). In the processing, sensitivity information of the text data acquired in the data acquisition processing is classified and extracted using a language comprehension algorithm that comprehends/determines a sentence structure and an adjacency relation of words. Specifically, the sensitivity information of data is classified and extracted in two stages, that is, three major categories “Positive”, “Neutral”, and “Negative” and a large number of minor categories subordinate to the respective major categories (see FIG. 27 to be described below).

Next, preservation data is created (STEP 25 in FIG. 3). Specifically, the preservation data is created in a manner that the sensitivity information extracted in the above-described extraction processing is associated with the text data acquired in the data acquisition processing described above.

Next, the preservation data created as described above is stored in the storage of the device body 1b as a part of the database (STEP 26 in FIG. 3). Then, the processing is completed.

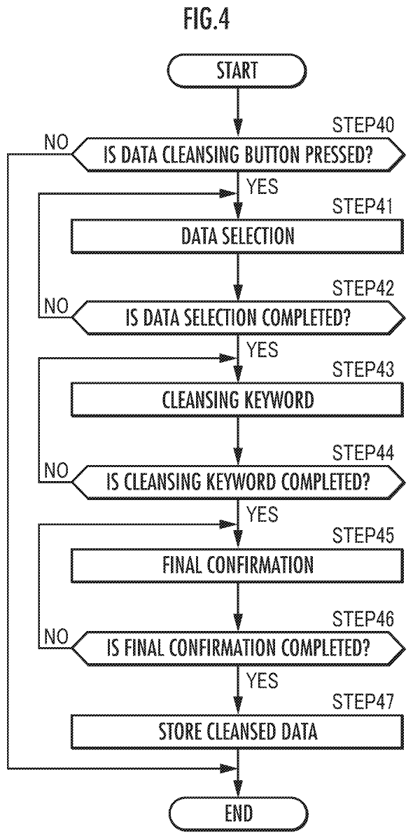

Contents of the data cleansing processing (STEP 2 in FIG. 2) described above will be described below with reference to FIG. 4. In such processing, as illustrated in FIG. 4, first, it is determined whether the above-described data cleansing button 20 is pressed by the user operation (STEP 40 in FIG. 4). When the determination is negative (NO in STEP 40 in FIG. 4), the processing is ended immediately.

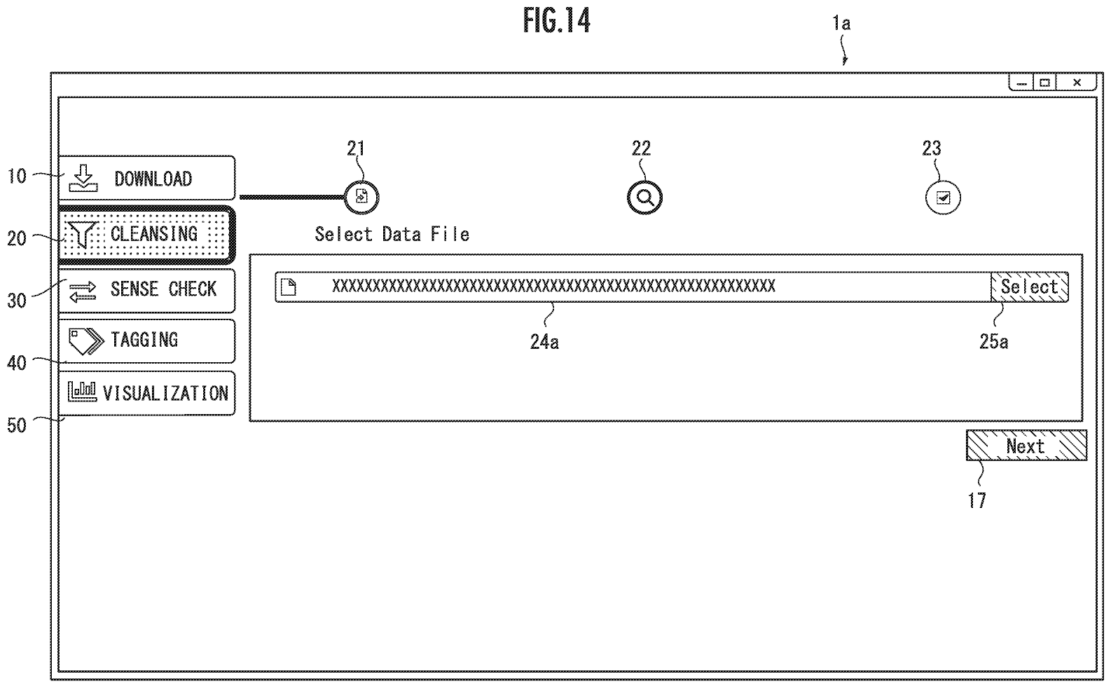

On the other hand, when the determination is affirmative (YES in STEP 40 in FIG. 4) and the data cleansing button 20 is pressed, data selection processing is executed (STEP 41 in FIG. 4). In order to indicate that data cleansing button 20 is pressed in this manner, the data cleansing button 20 is configured such that an outer frame is displayed with a thick line and an inside is displayed in a shaded state (see FIG. 14).

In the data selection processing, a data selection screen is displayed on the display 1a as illustrated in FIG. 14. On an upper side of the data selection screen, a data file selection icon 21, a cleansing keyword icon 22, and a final confirmation icon 23 are displayed in this order from left to right.

In order to indicate that the data selection processing is being executed, the data file selection icon 21 is inversely displayed, and characters “Select Data File” are displayed below the icon. At the same time, a display window 24a and a selection button 25a are displayed in a center of the data selection screen.

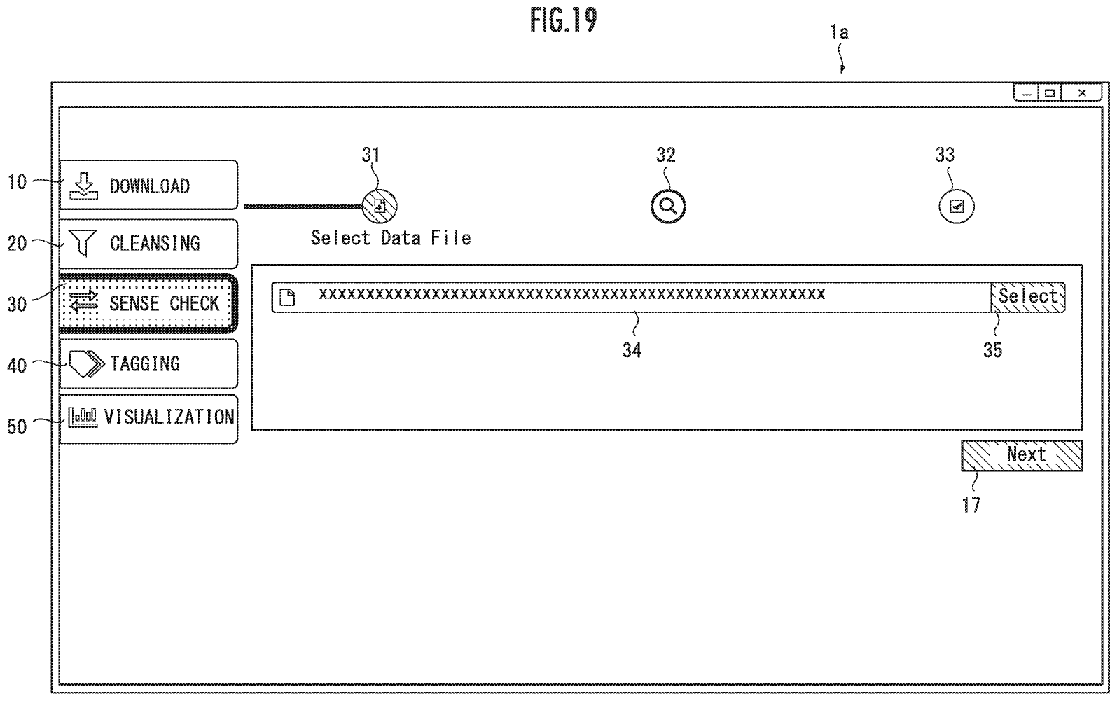

When the selection button 25a is pressed by the user operation, a menu screen (not illustrated) is displayed, and folders and data in the storage of the device body 1b are displayed (neither is illustrated). In such a state, when a data file to be subjected to the data cleansing processing by the user operation is selected, a path name of the folder in which the data file is stored and a data file name are displayed on the display window 24a. In the example illustrated in FIG. 14, the path name of the folder and the data file name are displayed in a form of “xxxxx . . . ”. This shall be applied to FIG. 19 to be described below.

In this case, when the respective processed of STEPs 1 to 4 illustrated in FIG. 2 are executed, the storage of the device body 1b stores, as a database, not only the preservation data described above, but also data files including cleansed data, sensitivity-corrected data, and tagged data which will be described below. In such a case, the user can arbitrarily select any of these four types of data files in the data selection processing. The data selection processing is executed as described above.

Next, it is determined whether the data selection processing is completed (STEP 42 in FIG. 4). In this case, when the Next button 17 is pressed by the user operation in the state where the path name of the folder and the data file name are displayed on the display window 24a as described above, it is determined that the data selection processing is completed, and it is determined in other cases that the data selection processing is not completed.

When the determination is negative (NO in STEP 42 in FIG. 4), the process returns to the above-described data selection processing. On the other hand, when the determination is affirmative (YES in STEP 42 in FIG. 4) and the data selection processing is completed, cleansing keyword processing is executed (STEP 43 in FIG. 4).

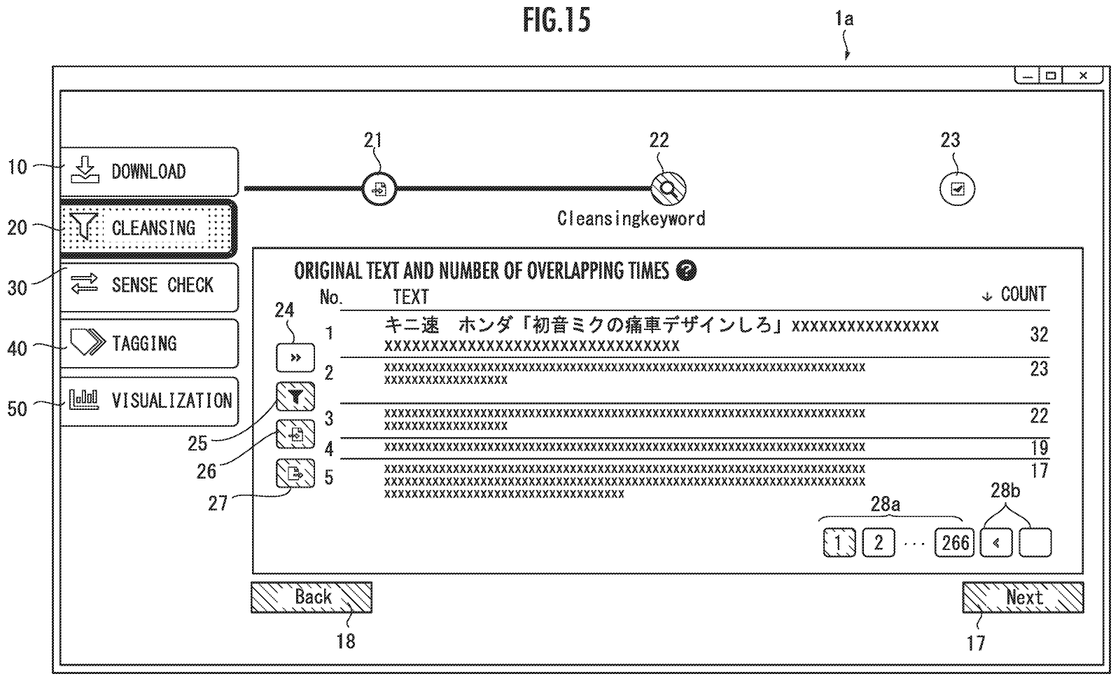

The cleansing keyword processing is to exclude unnecessary data from the data file selected as described above, and during execution of the cleansing keyword processing, a cleansing keyword screen is displayed on the display 1a as illustrated in FIG. 15. The cleansing screen illustrated in FIG. 15 is an example in which the above-described preservation data is selected in the above-described data selection processing.

In the cleansing keyword screen, the cleansing keyword icon 22 is inversely displayed and a character “Cleansingkeyword” is displayed on a lower side of the icon to indicate that the cleansing keyword processing is being executed.

Further, in a center of the cleansing keyword screen, text data in the data file are displayed from top to bottom in descending order of the number of overlapping times. In other words, when sets of completely matching text data exist in the data file, the sets are displayed in order from the largest set. Further, in each data, a ranking (No.) of the number of overlapping times, text data (TEXT), and the number of overlapping times (COUNT) are displayed from the left to the right.

On a left side of the text data, an operation button 24, a cleansing button 25, a keyword preservation button 26, and a keyword read button 27 are displayed in order from top to bottom. Further, on a lower right side of the text data, a large number of buttons 28a indicating the number of pages of the text data and buttons 28b and 28b configured to turn the pages of the text data are displayed.

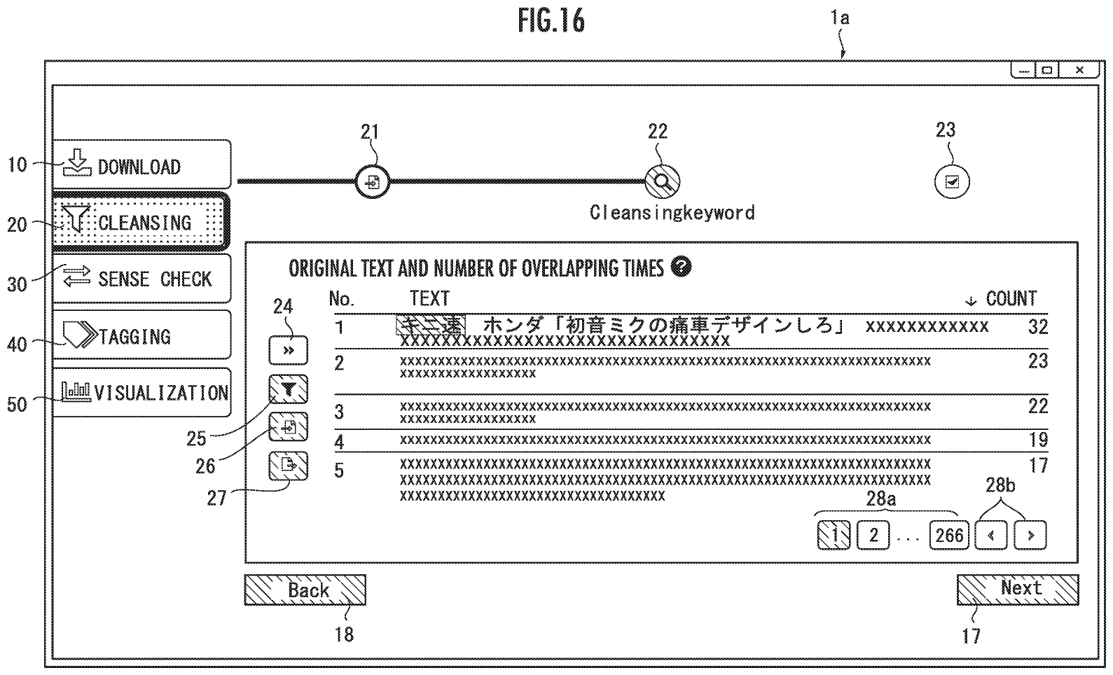

When the user visually recognizes the text data displayed on the cleansing keyword screen and finds unnecessary text data, the user presses the operation button 24 via the input interface 1c, and then selects an exclusion keyword (noise) included in the unnecessary text data with a pointer. Then, when the exclusion keyword is selected in such a way, the selected exclusion keyword (“Kini speed” (in Japanese “ [symbol] ”) in FIG. 16) is inversely displayed as illustrated in FIG. 16.

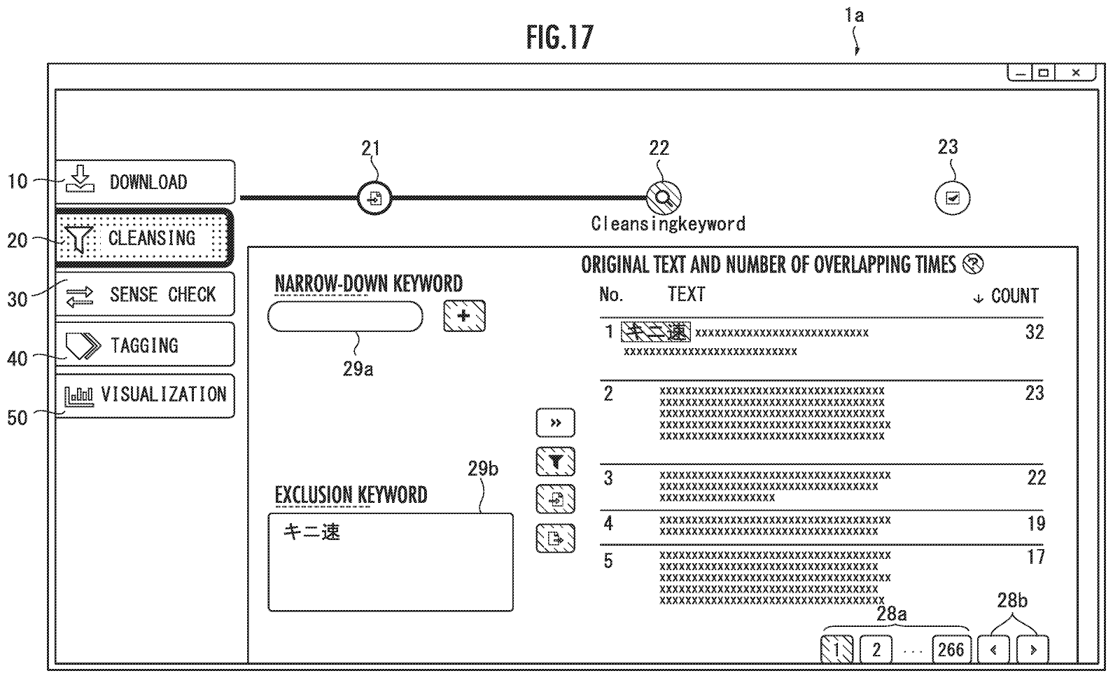

When the cleansing button 25 is pressed by the user operation on the cleansing keyword screen, as illustrated in FIG. 17, an input window 29a used to input a narrow-down keyword and a display window 29b used to display the selected exclusion keyword are displayed. Further, when the keyword preservation button 26 is pressed by the user operation, the exclusion keyword is stored in the storage of the device body 1b, and when the keyword read button 27 is pressed by the user operation, the exclusion keyword stored in the storage of the device body 1b is displayed on the display window 29b.

In addition, when the cleansing button 25 is pressed by the user operation in the screen display state illustrated in FIG. 17, all text data including the exclusion keyword are displayed in a deleted state (not illustrated). As described above, the cleansing keyword processing is executed.

Next, it is determined whether the cleansing keyword processing is completed (STEP 44 in FIG. 4). In this case, when the Next button 17 is pressed by the user operation in the state where the cleansing keyword screen is displayed, it is determined that the cleansing keyword processing is completed, and it is determined in other cases that the cleansing keyword processing is not completed.

When the determination is negative (NO in STEP 44 in FIG. 4), the process returns to the cleansing keyword processing described above. On the other hand, when the determination is affirmative (YES in STEP 44 in FIG. 4) and the cleansing keyword processing is completed, final confirmation processing is executed (STEP 45 in FIG. 4).

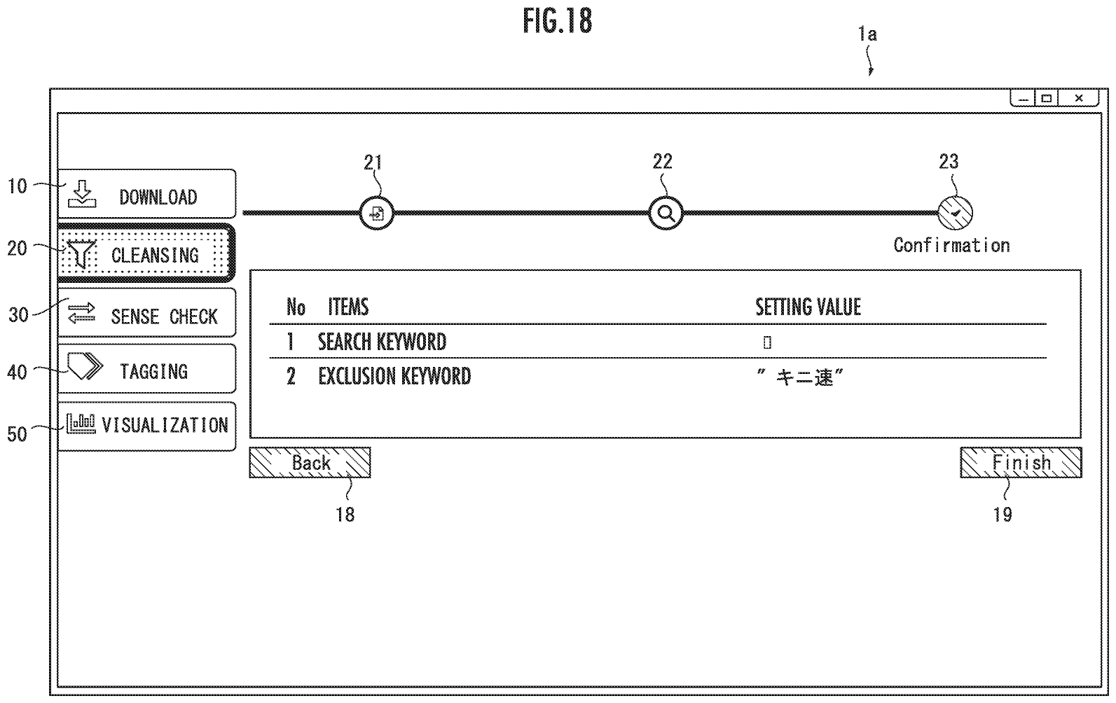

The final confirmation processing is to finally confirm the exclusion keyword selected by the user as described above, and during execution of the final confirmation processing, a final confirmation screen is displayed on the display 1a as illustrated in FIG. 18.

In the final confirmation screen, the final confirmation icon 23 is inversely displayed and a character “Confirmation” is displayed below the icon to indicate that the final confirmation processing is being executed. Further, the search keyword and the exclusion keyword input in the cleansing keyword processing are displayed in a center of the final confirmation screen. In the example illustrated in FIG. 18, since the search keyword is not input, “0” is displayed as the search keyword and “kini speed” is displayed as the exclusion keyword. The final confirmation processing is executed as described above.

Next, it is determined whether the final confirmation processing is completed (STEP 46 in FIG. 4). In this case, when the Finish button 19 is pressed by the user operation in the state where the final confirmation screen is displayed, it is determined that the final confirmation processing is completed, and it is determined in other cases that the final confirmation processing is not completed.

When the determination is negative (NO in STEP 46 in FIG. 4), the process returns to the final confirmation processing described above. On the other hand, when the determination is affirmative (YES in STEP 46 in FIG. 4) and the final confirmation processing is completed, cleansed data is stored in the storage of the device body 1b as a part of the database (STEP 47 in FIG. 4). The cleansed data is text data subjected to the data cleansing as described above. Thereafter, this processing is completed.

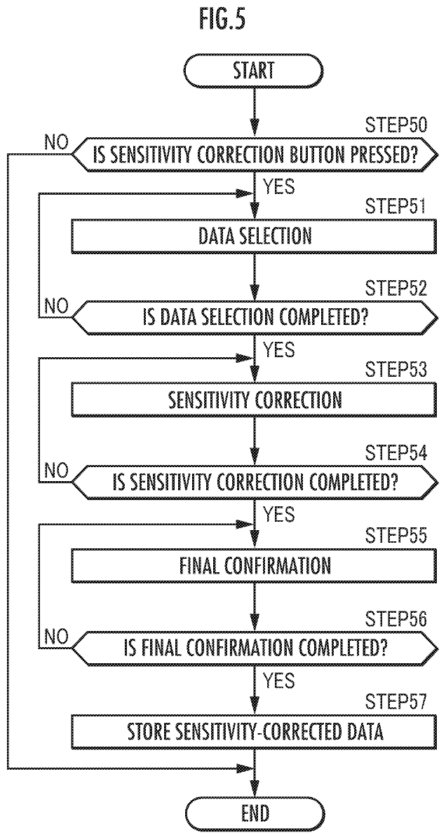

Contents of the above-described sensitivity information correction processing (STEP 3 in FIG. 2) will be described below with reference to FIG. 5. In this processing, as illustrated in FIG. 5, first, it is determined whether the above-described sensitivity correction button 30 is pressed by the user operation (STEP 50 in FIG. 5). When such determination is negative (NO in STEP 50 in FIG. 5), the processing is ended immediately.

On the other hand, when such determination is affirmative (YES in STEP 50 in FIG. 5), and the sensitivity correction button 30 is pressed, data selection processing is executed (STEP 51 in FIG. 5). In order to indicate that the sensitivity correction button 30 is pressed, the sensitivity correction button 30 is configured such that an outer frame is displayed with a thick line and an inside is displayed in a shaded state (see FIG. 19).

In the data selection processing, a data selection screen is displayed on the display 1a as illustrated in FIG. 19. On an upper side of the data selection screen, a data file selection icon 31, a sensitivity correction icon 32, and a final confirmation icon 33 are displayed in order from left to right.

In order to indicate that the data selection processing is being executed, the data file selection icon 31 is inversely displayed and characters “Select Data File” are displayed below the icon. At the same time, a display window 34 and a selection button 35 are displayed in a center of the data selection screen.

When the selection button 35 is pressed by the user operation, a menu screen (not illustrated) is displayed, and folders and data in the storage of the device body 1b are displayed (neither are illustrated). In such a state, when a data file to be subjected to sensitivity correction by the user operation is selected, a path name of the folder in which the data file is stored and a data file name are displayed on the display window 34.

Also in the data selection processing, when the preservation data, the cleansed data, the sensitivity-corrected data, and the database are stored in the storage of the device body 1b, the user can arbitrarily select any of these four types of data files. The data selection processing is executed as described above.

Next, it is determined whether the data selection processing is completed (STEP 52 in FIG. 5). In this case, when the Next button 17 is pressed by the user operation in the state where the path name of the folder and the data file name are displayed on the display window 34 as described above, it is determined that the data selection processing is completed, and it is determined in other cases that the data selection processing is not completed.

When the determination is negative (NO in STEP 52 in FIG. 5), the process returns to the above-described data selection processing. On the other hand, when the determination is affirmative (YES in STEP 52 in FIG. 5) and the data selection processing is completed, sensitivity correction processing is executed (STEP 53 in FIG. 5).

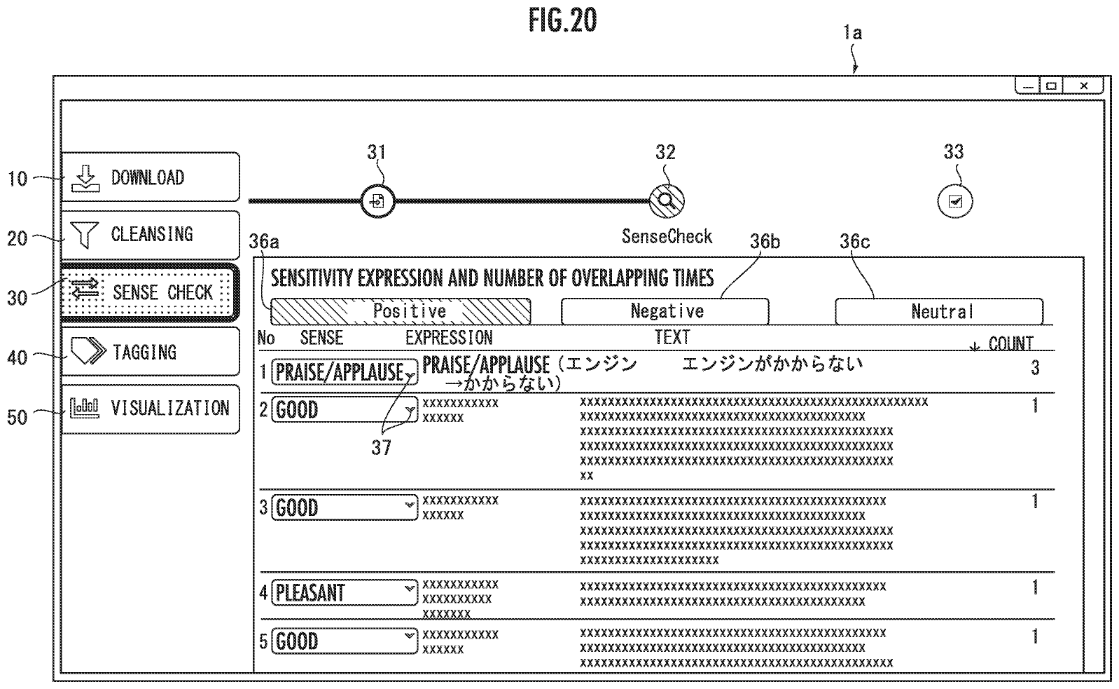

The sensitivity correction processing is to correct erroneous sensitivity information associated with the data file selected as described above, and during execution of the sensitivity correction processing, a sensitivity correction screen is displayed on the display 1a as illustrated in FIG. 20.

In the sensitivity correction screen, a sensitivity correction icon 32 is inversely displayed and a character “SenseCheck” is displayed below the icon to indicate that the sensitivity correction processing is being executed.

Further, on the sensitivity correction screen, tabs 36a to 36c of three major categories “Positive”, “Neutral”, and “Negative” are displayed from left to right. Then, when any of these tabs 36a to 36c is selected by the user operation, sensitivity information and text information are displayed.

For example, as illustrated in FIG. 20, the “Positive” tab 36a is inversely displayed to indicate that the “Positive” tab 36a is selected. At the same time, the text data in the data file is displayed from top to bottom in order from the largest number of overlapping times. Further, in each data, a ranking (No.) of the number of overlapping times, sensitivity information (SENSE), sensitivity expression (EXPRESSION), text data (TEXT), and the number of overlapping times (COUNT) are displayed from left to right.

When each data is displayed in this way, the user can determine whether the sensitivity information is correct with reference to the contents of the sensitivity information, the sensitivity expression and the text data which are displayed. For example, in the example illustrated in FIG. 20, although the sensitivity information is “praise/applause” in the data of No. 1, the user can determine that the sensitivity information is erroneous and should be corrected because the text data has a content that “an engine does not run (in Japanese “ [symbol] [symbol] ”)”.

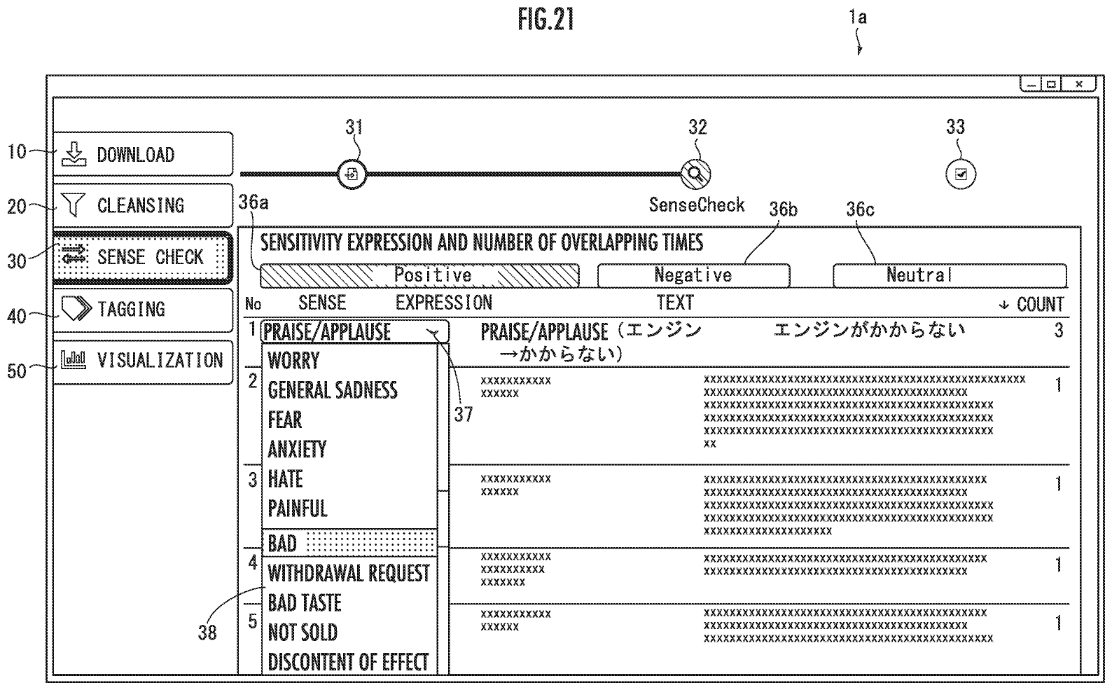

Then, in the case of correcting the sensitivity information in this way, the user operates the input interface 1c to press a pull-down menu button 37 located on a right side of the display window of the sensitivity information of the No. 1 data. In response, as illustrated in FIG. 21, a pull-down menu 38 is displayed, so that the user operates the input interface 1c to select appropriated information among various types of sensitivity information in the pull-down menu 38. For example, in the example illustrated in FIG. 21, sensitivity information “bad” is selected, and the sensitivity information “bad” is displayed in a form of dots to indicate the selected state. As described above, the sensitivity correction processing is executed.

Next, it is determined whether the sensitivity correction processing is completed (STEP 54 in FIG. 5). In this case, when the Next button 17 is pressed by the user operation in the state where the sensitivity correction screen is displayed, it is determined that the sensitivity correction processing is completed, and it is determined in other cases that the sensitivity correction processing is not completed.

When the determination is negative (NO in STEP 54 in FIG. 5), the process returns to the sensitivity correction processing described above. On the other hand, when the determination is affirmative (YES in STEP 54 in FIG. 5) and the sensitivity correction processing is completed, final confirmation processing is executed (STEP 55 in FIG. 5).

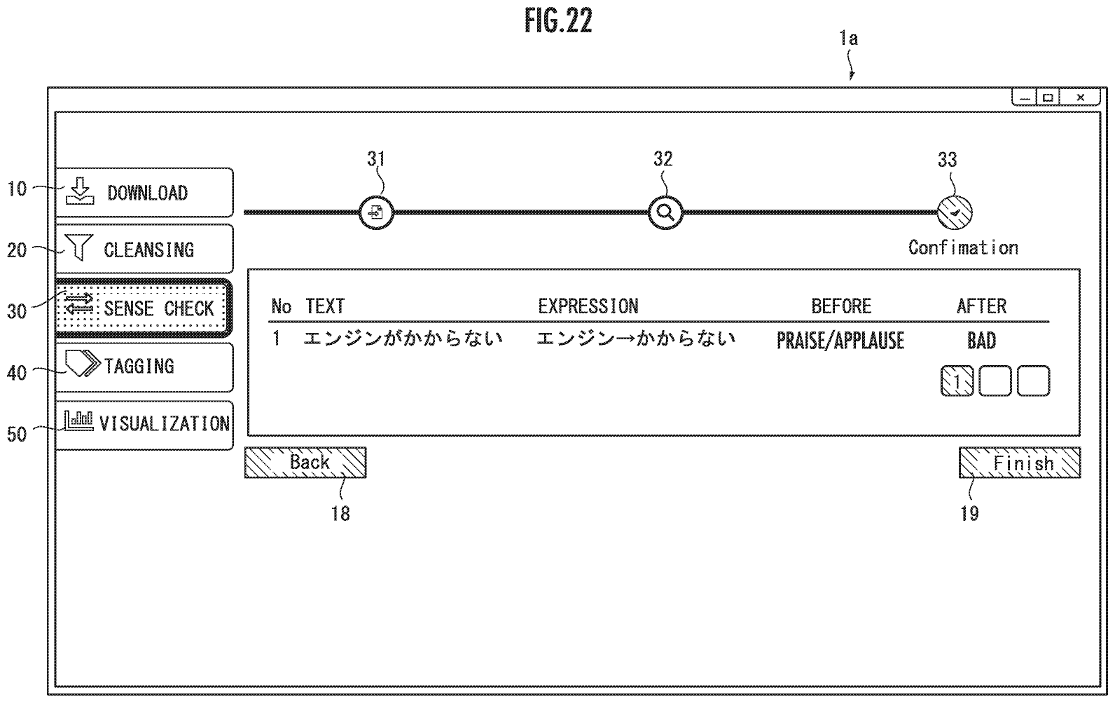

The final confirmation processing is to finally confirm the sensitivity information corrected by the user as described above, and during execution of the final confirmation processing, a final confirmation screen is displayed on the display 1a as illustrated in FIG. 22.

In the final confirmation screen, the final confirmation icon 33 is inversely displayed and a character “Confirmation” is displayed below the icon to indicate that the final confirmation processing is being executed. Further, in a center of the final confirmation screen, text data (TEXT), expression (EXPRESSION), sensitivity information before correction (BEFORE), and sensitivity information after correction (AFTER) are displayed from left to right. In the example illustrated in FIG. 22, “praise/applause” is displayed as the sensitivity information before correction, and “bad” is displayed as the sensitivity information after correction. The final confirmation processing is executed as described above.

Next, it is determined whether the final confirmation processing is completed (STEP 56 in FIG. 5). In this case, when the Finish button 19 is pressed by the user operation in the state where the final confirmation screen is displayed, it is determined that the final confirmation processing is completed, and it is determined in other cases that the final confirmation processing is not completed.

When the determination is negative (NO in STEP 56 in FIG. 5), the process returns to the final confirmation processing described above. On the other hand, when the determination is affirmative (YES in STEP 56 in FIG. 5) and the final confirmation processing is completed, the sensitivity-corrected data is stored in the storage of the device body 1b as a part of the database (STEP 57 in FIG. 5). The sensitivity-corrected data is text data in which the sensitivity information associated with the text data is corrected as described above. Thereafter, this processing is completed.

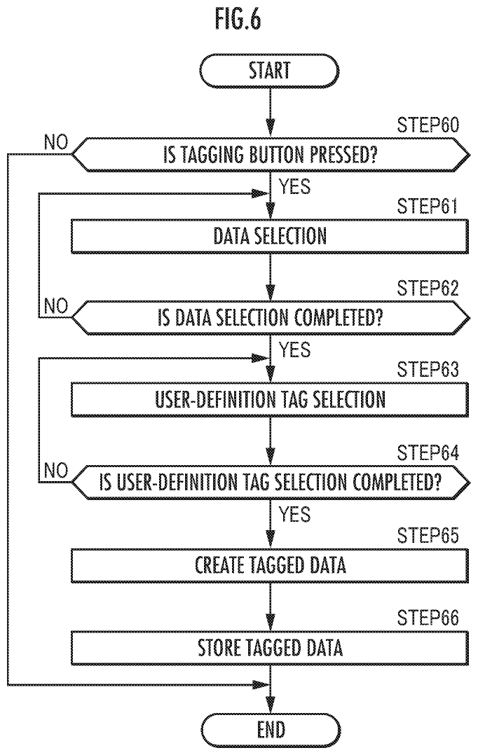

The contents of the above-described user-definition tagging processing (STEP 4 in FIG. 2) will be described below with reference to FIG. 6. In this processing, as illustrated in FIG. 6, first, it is determined whether the above-described tagging button 40 is pressed by the user operation (STEP 60 in FIG. 6). When such determination is negative (NO in STEP 60 in FIG. 6), the processing is ended immediately.

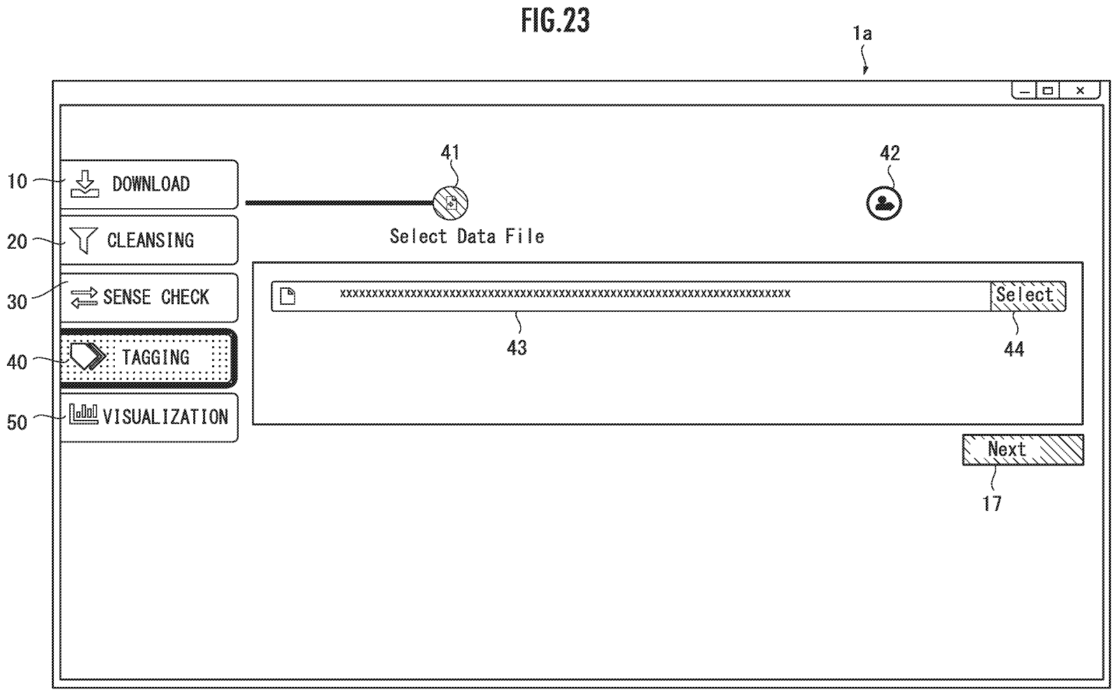

On the other hand, when such determination is affirmative (YES in STEP 60 in FIG. 6), and the tagging button 40 is pressed, data selection processing is executed (STEP 61 in FIG. 6). In order to indicate that the tagging button 40 is pressed, the tagging button 40 is configured such that an outer frame is displayed with a thick line and an inside is displayed in a shaded state (see FIG. 23).

The data selection processing is to select a data file to which a user-definition tag to be described below is added, and during execution of the data selection processing, a data selection screen is displayed on the display 1a as illustrated in FIG. 23. On an upper side of the data selection screen, a data file selection icon 41 and a user-definition tag selection icon 42 are displayed in order from left to right.

In order to indicate that the data selection processing is being executed, the data file selection icon 41 is inversely displayed and characters “Select Data File” are displayed below the icon. At the same time, a display window 43 and a selection button 44 are displayed in a center of the data selection screen.

When the selection button 44 is pressed by the user operation, a menu screen (not illustrated) is displayed, and folders and data in the storage of the device body 1b are displayed (neither are illustrated). In such a state, when a data file is selected by the user operation, a path name of the folder in which the data file is stored and a data file name are displayed on the display window 43.

Also in the data selection processing, when the preservation data, the cleansed data, the sensitivity-corrected data, and the database are stored in the storage of the device body 1b, the user can arbitrarily select any of these four types of data files. The data selection processing is executed as described above.

Next, it is determined whether the data selection processing is completed (STEP 62 in FIG. 6). In this case, when the Next button 17 is pressed by the user operation in the state where the path name of the folder and the data file name are displayed on the display window 43 as described above, it is determined that the data selection processing is completed, and it is determined in other cases that the data selection is not completed.

When the determination is negative (NO in STEP 62 in FIG. 6), the process returns to the above-described data selection processing. On the other hand, when the determination is affirmative (YES in STEP 62 in FIG. 6) and the data selection processing is completed, user-definition tag selection processing is executed (STEP 63 in FIG. 6).

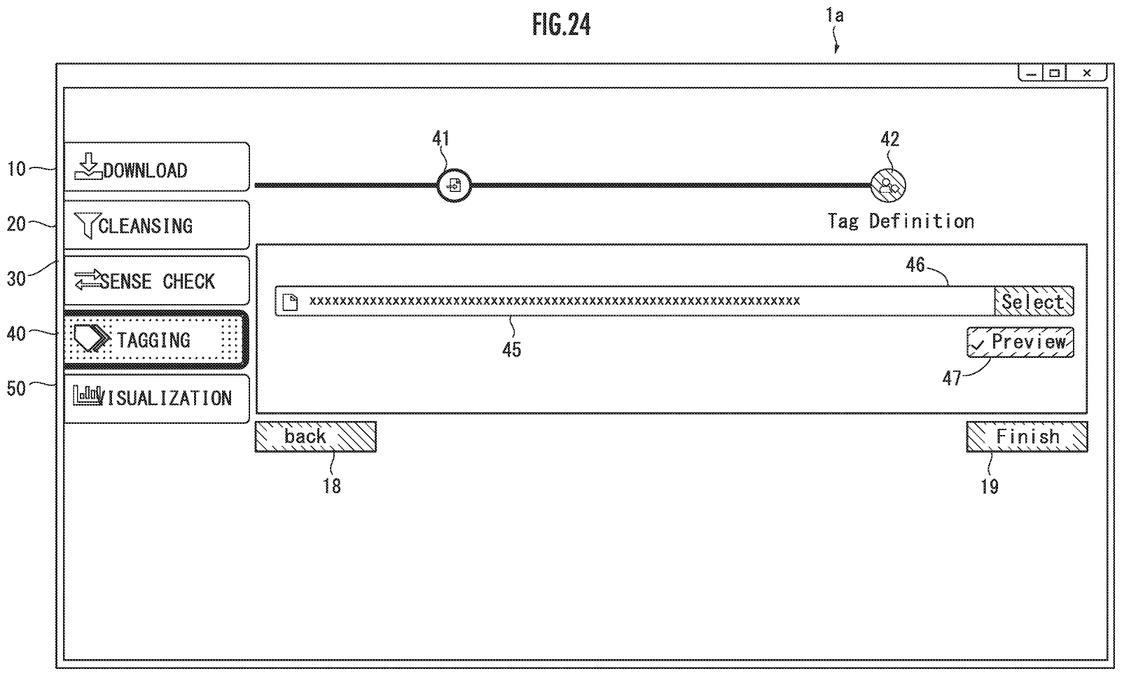

The user-definition tag selection processing is to select the user-definition tag associated with the data file selected as described above, and during execution of the user-definition tag selection processing, a user-definition tag selection screen is displayed on the display 1a as illustrated in FIG. 24.

In the user-definition tag selection screen, the user-definition tag selection icon 42 is inversely displayed and characters “Tag Definition” are displayed below the icon to indicate that the user-definition tag selection processing is being executed. At the same time, a display window 45 and a selection button 46 are displayed in a center of the user-definition tag selection screen, and a preview button 47 is displayed below the selection button 46.

When the selection button 46 is pressed by the user operation, a menu screen (not illustrated) is displayed, and folders and data in the storage of the device body 1b are displayed (neither are illustrated). In such a state, when a user-definition tag file tagged with the text data is selected by the user operation, a path name of the folder in which the user-definition tag file is stored and a user-definition tag file name are displayed on the display window 45.

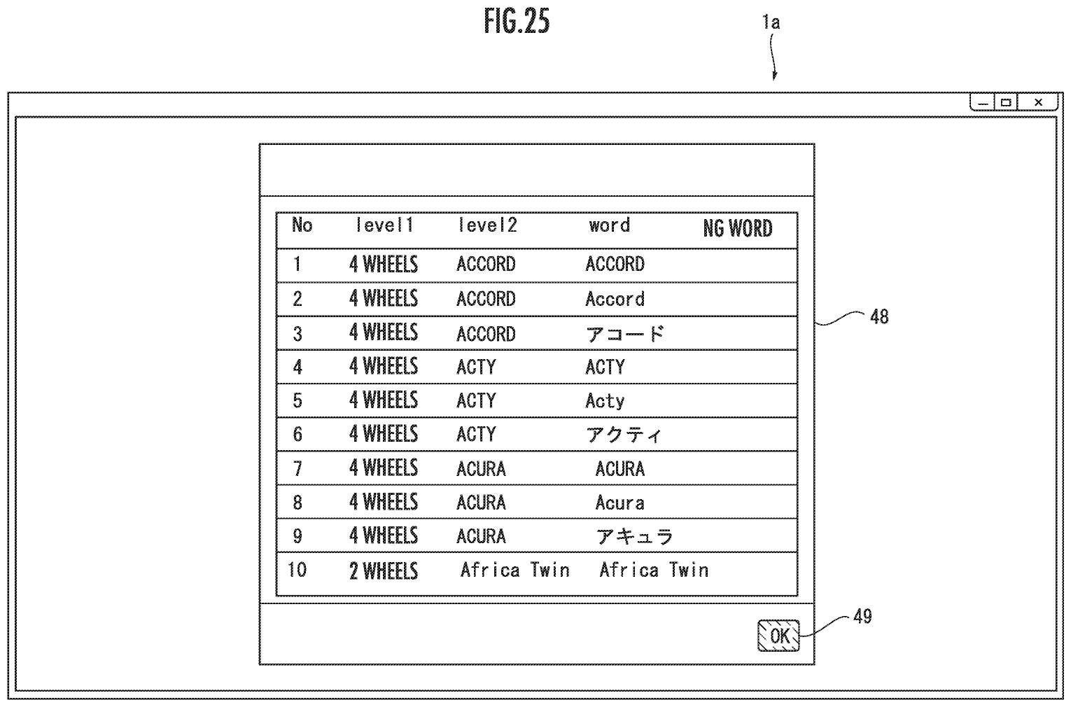

As described above, when the preview button 47 is pressed by the user operation in the state where the user-definition tag file name is displayed on the display window 45, a user-definition tag screen is displayed on the display 1a as illustrated in FIG. 25. A tag list 48 and an OK button 49 are displayed on the user-definition tag screen. In the tag list 48, a major category (level 1), a minor category (level 2), and a character string (word) are displayed from left to right. These categories and the character string are predefined by the user.

In the example illustrated in FIG. 25, “4 wheels” and “2 wheels” are defined as the major categories, and car names “ACCORD (registered trademark)”, “ACTY (registered trademark)”, and “Africa Twin” and a brand name “ACURA (registered trademark)” are defined as the minor categories. Further, in addition to the car names and the brand name described above written in Roman letters, car names written in katakana “ [symbol] (registered trademark)” and “ [symbol] [symbol] (registered trademark)” and a brand name written in katakana “ [symbol] (registered trademark)” are defined as the character strings.

The user can confirm the contents of the user-definition tag file selected by himself/herself with reference to the tag list 48. Further, the user can return to the screen display illustrated in FIG. 24 by operating the input interface 1c and pressing the OK button 49. The user-definition tag selection processing is executed as described above.

Next, it is determined whether the user-definition tag selection processing is completed (STEP 64 in FIG. 6). In this case, when the Finish button 19 is pressed by the user operation in the state where the path name of the folder of the user-definition tag file and the user-definition tag file name are displayed on the display window 45, it is determined that the user-definition tag selection processing is completed, and it is determined in other cases that the user-definition tag selection processing is not completed.

When the determination is negative (NO in STEP 64 in FIG. 6), the process returns to the user-definition tag selection processing described above. On the other hand, when the determination is affirmative (YES in STEP 64 in FIG. 6) and the user-definition tag selection processing is completed, tagged data is created by tagging the text data with the user-definition tag file selected as described above (STEP 65 in FIG. 6).

Next, the tagged data is stored in the storage of the device body 1b as a part of the database (STEP 66 in FIG. 6). Thereafter, the processing is ended immediately.

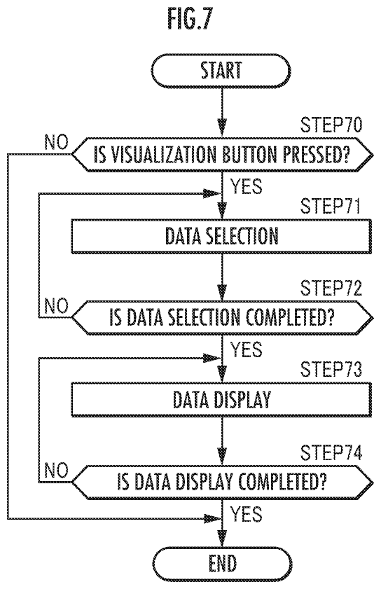

The contents of the above-described data visualization processing (STEP 5 in FIG. 2) will be described below with reference to FIG. 7. In this processing, as illustrated in FIG. 7, first, it is determined whether the above-described visualization button 50 is pressed by the user operation (STEP 70 in FIG. 7). When such determination is negative (NO in STEP 70 in FIG. 7), the processing is ended immediately.

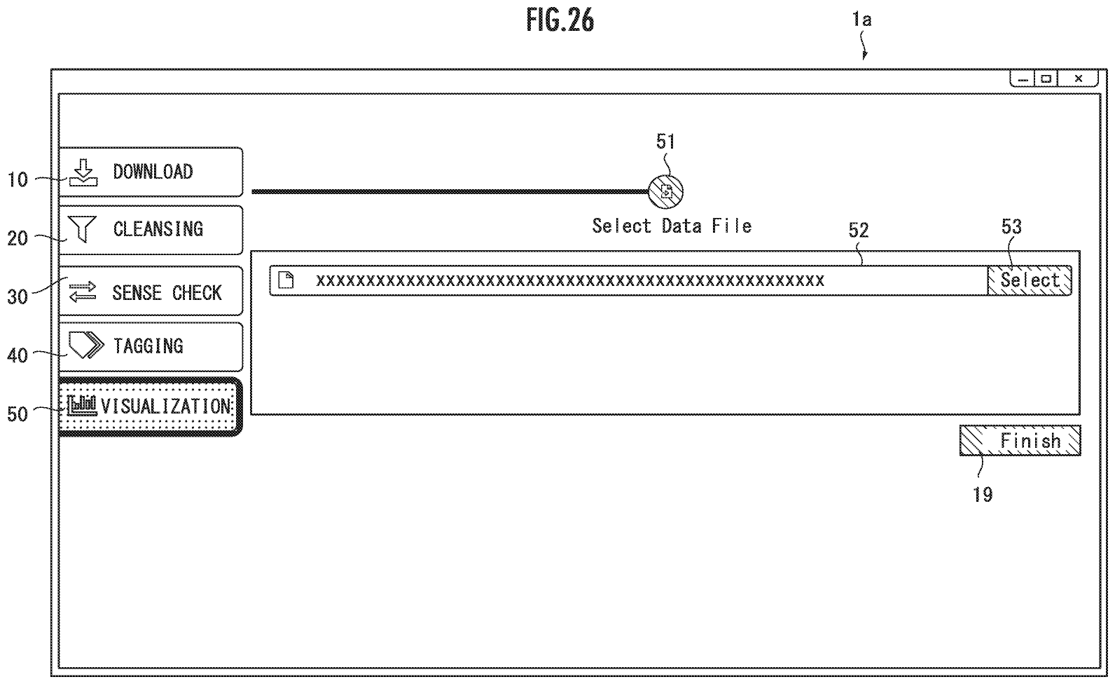

On the other hand, when such determination is affirmative (YES in STEP 70 in FIG. 7), and the visualization button 50 is pressed, data selection processing is executed (STEP 71 in FIG. 7). In order to indicate that the visualization button 50 is pressed, the visualization button 50 is configured such that an outer frame is displayed with a thick line and an inside is displayed in a shaded state (see FIG. 26).

The data selection processing is to select a data file of the database to be displayed as a graph, and during execution of the data selection processing, a data selection screen is displayed on the display 1a as illustrated in FIG. 26.

On an upper side ofthe data selection screen, a data file selection icon 51 is displayed. In order to indicate that the data selection processing is being executed, the data file selection icon 51 is inversely displayed and characters “Select Data File” are displayed below the icon. At the same time, a display window 52 and a selection button 53 are displayed in a center of the data selection screen.

When the selection button 53 is pressed by the user operation, a menu screen (not illustrated) is displayed, and folders and data in the storage of the device body 1b are displayed (neither are illustrated). In such a state, when a data file of the database is selected by the user operation, a path name of the folder in which the data file is stored and a data file name are displayed on the display window 52.

Also in the data selection processing, when the preservation data, the cleansed data, the sensitivity-corrected data, and the database are stored in the storage of the device body 1b, the user can arbitrarily select any of these four types of data files. The data selection processing is executed as described above.

Next, it is determined whether the data selection processing is completed (STEP 72 in FIG. 7). In this case, when the Finish button 19 is pressed by the user operation in the state where the path name of the folder and the data file name are displayed on the display window 52 as described above, it is determined that the data selection processing is completed, and it is determined in other cases that the data selection is not completed.

When the determination is negative (NO in STEP 72 in FIG. 7), the process returns to the above-described data selection processing. On the other hand, when the determination is affirmative (YES in STEP 72 in FIG. 7) and the data selection processing is completed, data display processing is executed (STEP 73 in FIG. 7).

The data display processing is to display various data items in the data file selected as described above in a graph so that the user can visually recognize them. A description will be given with respect to an example of displaying a data file in which the text data file acquired in the above-described data acquisition processing is subjected to all the data cleansing processing, the sensitivity information correction processing, and the user-definition tagging processing.

During execution of the data display processing, an initial display screen is displayed on the display 1a as illustrated in FIG. 27. As illustrated in FIG. 27, three major categories of sensitivity information “Positive”, “Neutral”, and “Negative” are displayed in the form of an annular graph (donut graph) on a top left side in the initial display screen. In such a graph, areas of the three major categories are set according to the proportion (%) of the number of hits, and are displayed in different colors. In addition, the names and the proportions of the number of hits of respective major categories are displayed adⱼacent to the graph. Thus, the user can determine the proportions of the three major categories of the sensitivity information in the search results at a glance.

On a right side of the annular graph, a large number of minor categories (for example, “question”, “inquiry”, and “request”) subordinate to the sensitivity information “Neutral” are displayed in the form of a bar graph. In the case of the bar graph, a horizontal axis indicates the number of hits, and this also applies to bar graphs below.

Further, below the annular graph showing the proportions of the three major categories, a large number of minor categories (for example, “good”, “want to buy”, and “thank you”) subordinate to the sensitivity information “Positive” are displayed in the form of a bar graph. Below the bar graph of the sensitivity information “Neutral”, a large number of minor categories (for example, “bad”, “discontent”, and “being in trouble”) subordinate to the sensitivity information “Negative” are displayed in the form of a bar graph.

In addition, below the bar graph of the sensitivity information “Positive”, a large number of minor categories (for example, “N BOX (registered trademark), FIT (registered trademark), and FREED (registered trademark)) subordinate to the major category of the user-definition tag “4 wheels” are displayed in the form of a bar graph. Further, below the bar graph of the sensitivity information “Negative”, a large number of minor categories (for example, “CUB”, “BIO”, and “GOLD WING (registered trademark)”) subordinate to the major category of the user-definition tag “2 wheels” are displayed in the form of a bar graph.

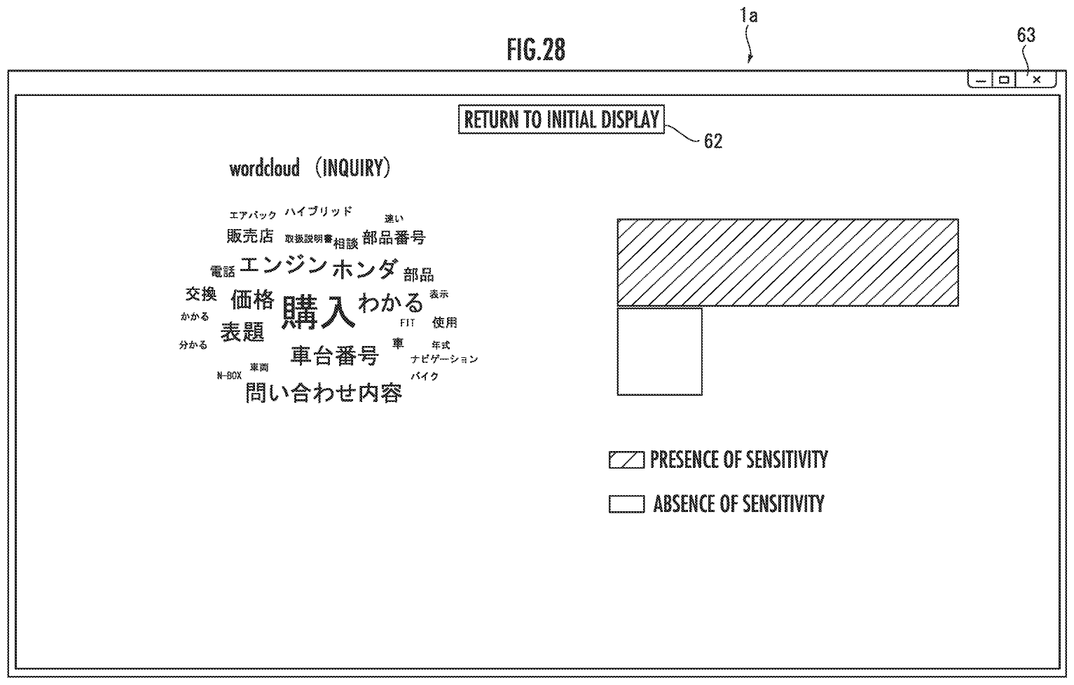

In the bar graph of the sensitivity information “Neutral” on the initial display screen illustrated in FIG. 27, for example, when a bar graph 60 of the minor category “inquiry” is clicked by the user operation, a related screen of the minor category “inquiry” (hereinafter, referred to as “inquiry related screen”) is displayed as illustrated in FIG. 28. As illustrated in FIG. 28, on the inquiry related screen, related words of the sensitivity information “inquiry” are displayed in a word cloud format, with a keyword “purchase (in Japanese “ [symbol] ”)” at a center and words related to the keyword and having a large number of hits. Further, a proportion of presence/absence of the sensitivity information is displayed in the form of a bar graph on a right side of the inquiry related screen.

On the other hand, a return button 62 is displayed above a center of the inquiry related screen. When the return button 62 is pressed by the user operation, the screen displayed on the display 1a returns to the initial display screen from the inquiry related screen. In the bar graph of the sensitivity information “Neutral” on the initial display screen illustrated in FIG. 27, when a bar graph of the minor category (for example, “question”) other than the minor category “inquiry” is also clicked, the same screen as in FIG. 28 is displayed.

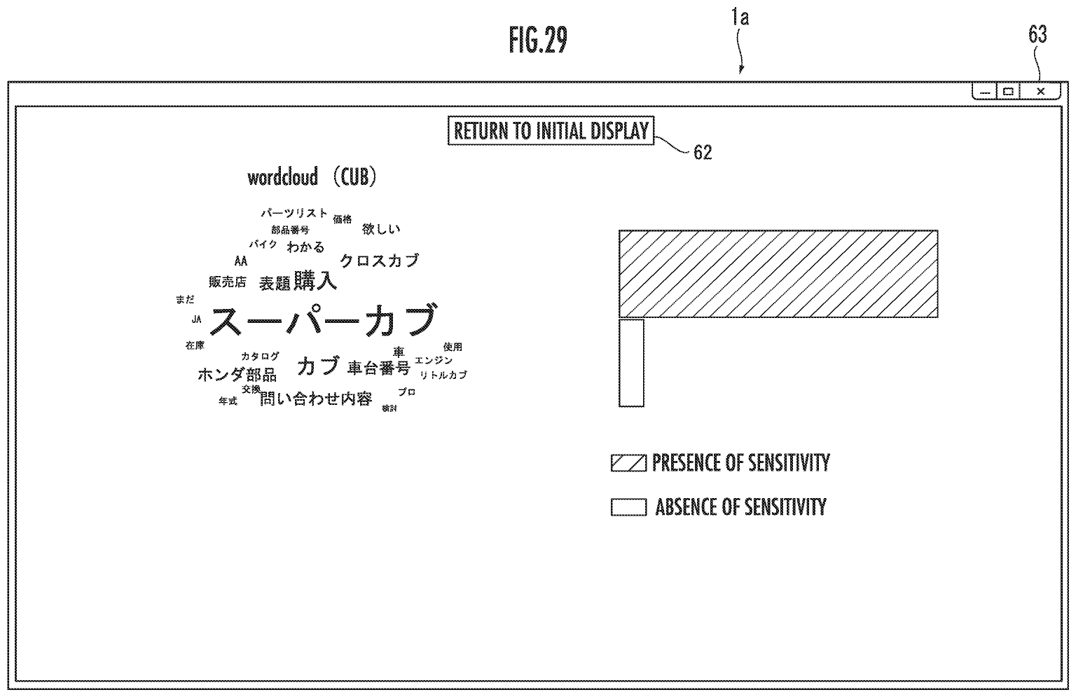

In the bar graph of the major category “2 wheels” of the user definition on the initial display screen illustrated in FIG. 27, for example, when a bar graph 61 of the minor category “CUB” is clicked by the user operation, a related screen of the minor category “CUB” (hereinafter, referred to as “CUB related screen”) is displayed as illustrated in FIG. 29. As illustrated in FIG. 29, on the CUB related screen, related words of the minor category “CUB” of the user-definition tag are displayed in a word cloud format, with a keyword “super cub (in Japanese “ [symbol] [symbol] ”)” at a center and words related to the keyword and having a large number of hits. Further, a proportion of presence/absence ofthe sensitivity information is displayed in the form of a bar graph on a right side of the CUB related screen.

A return button 62 is displayed above a center of the CUB related screen illustrated in FIG. 29. When the return button 62 is pressed by the user operation, the screen displayed on the display 1a returns to the initial display screen from the CUB related screen. In the bar graph of the major category “2 wheels” on the initial display screen illustrated in FIG. 27, when a bar graph of the minor category (for example, “BIO”) other than the minor category “CUB” is also clicked, the same screen as in FIG. 29 is displayed. The data display processing is executed as described above.

Next, it is determined whether the data display processing is completed (STEP 74 in FIG. 7). In this case, when an end button 63 located at an upper right side of the screen is pressed by the user operation in the state where any of the screens of FIGS. 27 to 29 is displayed on the display 1 a, it is determined that the data display processing is completed, and it is determined in other cases that the data display processing is not completed.

When the determination is negative (NO in STEP 74 in FIG. 7), the process returns to the data display processing described above. On the other hand, when the determination is affirmative (YES in STEP 74 in FIG. 7) and the data display processing is completed, the data visualization processing is ended immediately.

As described above, according to the data processing device 1 of the present embodiment, after conditions of a media, a search period, a language, and a search keyword & exclusion keyword are determined as predetermined acquisition conditions by the user operation in the data acquisition processing, the text data is acquired from the external server 4. Then, the acquired text data is stored as preservation data in the storage of the device body 1b.

In this case, even when the text data including the keyword equal to or similar to the search keyword is present in the external server 4 as the exclusion keyword that is not related to the search keyword, since the keyword that can avoid the acquisition of the text data is input by the user operation, the text data related to the search keyword can be accurately acquired.

In the data cleansing processing, when the user finds unnecessary text data on the cleansing keyword screen, the user can delete all text data including the exclusion keyword and create the cleansed data by selecting the exclusion keyword included in the unnecessary text data and pressing the cleansing button 25.

At this time, since the text data in the data file is displayed from top to bottom in order from the largest number of overlapping times on the cleansing keyword screen, the user can select the exclusion keyword in order from the largest number of overlapping times of the text information. Therefore, the text information including the exclusion keyword as noise can be efficiently removed from the plurality of text information items.

Since the exclusion keyword input by the user is displayed on the cleansing keyword screen, the user can visually recognize the exclusion keyword selected up to the present time by the user. Thereby, convenience can be improved.

Further, since the sensitivity information and the text data are displayed on the sensitivity correction screen in the sensitivity information correction processing, the user can easily correct the sensitivity information while visually recognizing the displayed contents.

In addition, since the database is created by associating the user-definition tag with the text data in the user-definition tagging processing, the database search can be executed based on the user-definition tag information, and the usefulness of the database can be further improved.

Since the sensitivity information of the three major categories included in the database are displayed on the display 1a in the data visualization processing such that the colors are different from each other and the proportions thereof are known, the user can easily and visually recognize the proportions of the sensitivity information of the three major categories.

Although the embodiment is an example in which the personal computer-type data processing device 1 is used as the data processing device, the data processing device of the present invention may include the output interface, the input interface, the text information acquisition unit, the noise-removed information creation unit, and the database creation unit without being limited thereto. For example, a configuration in which the personal computer-type data processing device 1 and the main server 2 are combined may be used as the data processing device. In addition, a tablet terminal may be used as the data processing device, and a configuration in which the tablet terminal and the main server 2 are combined may be used as the data processing device.

Further, although the embodiment is an example in which the display 1a is used as the output interface, the output interface of the present invention may be any one capable of displaying a plurality of types of text information without being limited thereto. For example, one monitor or one touch panel-type monitor may be used as the output interface. In addition, a 3D hologram device or a head-mounted VR device may be used as the output interface.

Further, although the embodiment is an example in which the input interface 1c including the keyboard and the mouse is used as the input interface, the input interface of the present invention may be any one in which various operations are executed by the user without being limited thereto. For example, an optical pointing device such as a laser pointer may be used as the input interface, or contact-type devices such as a touch panel and a touch pen may be used as the input interface. Further, a contactless device capable of converting voice into various operations may be used as the input interface.

On the other hand, although the embodiment is an example in which conditions obtained by combinations of the search period, the search language, the search keyword, and the exclusion keyword, and the additional information are used as the predetermined acquisition conditions, the predetermined acquisition conditions of the present invention may use other conditions without being limited thereto. For example, as the predetermined acquisition conditions, conditions in which the search keyword and the exclusion keyword are further added to the above-described acquisition condition may be used.

In the embodiment, when the text data is displayed on the cleansing keyword screen as illustrated in FIG. 15, the set of the completely matching text data is displayed in order from the largest number of overlapping times, but sets of text data that collects the completely matching text data and the text data of one character or two characters difference text data (approximate information) may be created and the sets may be displayed in order from the largest set.

Further, although the embodiment is an example in which the exclusion keyword (Kini speed) is used as the noise, the noise of the present invention may be at least a part of each of the plurality of text information items without being limited thereto. For example, a combination of a plurality of words may be used as the noise.

On the other hand, the embodiment is an example in which SNS media configured by the external server 4 are used as the predetermined media, but the predetermined media of the present invention may be hardware such as TV and radio, or a mass media whose information is published on paper such as a newspaper without being limited thereto. In this case, when mass media such as TV, radio, and newspaper are used as the predetermined media, information (moving picture information, voice information, and character information) published on TV, radio, and newspaper may be input as text data via an input interface such as a personal computer.

In addition, although the embodiment is an example in which the sensitivity information is classified into two levels, that is, a major category and a minor category, the sensitivity information of the present invention may be classified into a plurality of levels from the highest level to the lowest level without being limited thereto. For example, the sensitivity information may be classified into three or more levels.

What is claimed is:

1. A data processing device comprising:
an output interface;
an input interface configured to be operated by a user;
a text information acquisition unit configured to acquire a plurality of text information items from information published on a predetermined media under a predetermined acquisition condition;
a text information display unit configured to display the plurality of text information items on the output interface;
a noise-removed information creation unit configured to, when at least a part of each of the plurality of text information items displayed on the output interface is designated as noise by an operation of the input interface from the user, create a noise-removed information item which is text information obtained by removing text information including the part designated as the noise from the plurality of text information items; and
a database creation unit configured to create a database by performing predetermined processing on the noise-removed information item.

2. The data processing device according to claim 1, further comprising:
a noise storage unit configured to store the noise; and
a noise display unit configured to display the noise stored in the noise storage unit on the output interface when a display operation of the noise is executed by the operation of the input interface from the user.

3. The data processing device according to claim 1, wherein the text information acquisition unit extracts sensitivity information from the information published on the predetermined media, and acquires the plurality of text information items as information in which the sensitivity information is associated with the information published on the predetermined media,
the data processing device further includes a noise-removed information display unit configured to display the noise-removed information item on the output interface together with the sensitivity information associated with the noise-removed information item, and
the predetermined processing of the database creation unit includes sensitivity information correction processing of correcting the sensitivity information in the one or more noise-removed information items displayed on the output interface, the sensitivity information correction processing being executed by the operation of the input interface from the user.

4. The data processing device according to claim 1, further comprising a tag information storage unit configured to store tag information defined by the user, wherein the predetermined processing of the database creation unit includes association processing of associating the noise-removed information item with the tag information stored in the tag information storage unit.

5. The data processing device according to claim 1, wherein the text information display unit displays sets of text information on the output interface in order from a largest size, the sets of text information each including identical information or identical and similar information when the plurality of text information items are sorted according to meaning of information included in the plurality of text information items.

6. The data processing device according to claim 3, wherein
the database creation unit creates the database in a state where the sensitivity information is sorted into a plurality of categories, and
the data processing device includes a sensitivity information display unit configured to display the sensitivity information on the output interface in different colors, the sensitivity information being sorted into the plurality of categories and included in the database.

7. The data processing device according to claim 1, wherein the predetermined acquisition condition is a condition that the information published on the predetermined media includes predetermined information and does not include predetermined confusion information which is confusable with the predetermined information.

8. A data processing method comprising:
acquiring a plurality of text information items from information published on a predetermined media under a predetermined acquisition condition;
displaying the plurality of text information items on an output interface;
creating, when at least a part of each of the plurality of text information items displayed on the output interface is designated as noise by an operation of an input interface from a user, a noise-removed information item which is text information obtained by removing text information including the part designated as the noise from the plurality of text information items; and
creating a database by performing predetermined processing on the noise-removed information item.
